(19) United States
(12) Patent Application Publication
(10) Pub. No.: US 2001/0053991 A1
(43) Pub. Date: Dec. 20, 2001

(54) Methods and systems for generating business models

(76) Inventor: Eric W. Bonabeau, Paris (FR)

Correspondence Address: PENNIE AND EDMONDS, 1155 AVENUE OF THE AMERICAS, NEW YORK, NY, 100362711

(21) Appl. No.: 09/801,130

(22) Filed: Mar. 7, 2001

Related U.S. Application Data
(60) Provisional application No. 60/187,889, filed on Mar. 8, 2000.

(51) Int. Cl. G06G 7/48; G06F 17/60

(52) U.S. Cl. 705/7; 703/6

(57) ABSTRACT

The present invention relates generally to methods and systems for generating new business models in an environment of existing business methods. More particularly, the present invention describes existing business methods with corresponding business models, simulates the business models to determine their performances, selects one or more of the business models having optimal performance values, and transforms the selected business models to create new improved business methods. In preferred embodiments, the present invention describes a space of possible business models in a modular fashion and applies evolutionary methods to generate improved business models. In preferred embodiments, the business models are simulated as part of a business ecosystem including other interacting business models and customers patronizing the business models. The present invention also includes systems for performing the methods, and use of generated business models in real-world business situations.

A portion of the disclosure of this patent document contains material which is subject to copyright protection. The copyright owner has no objection to the facsimile reproduction by any one of the patent document or the patent disclosure, as it appears in the Patent and Trademark Office patent files or records, but otherwise reserves all copyright rights whatsoever.

### FIELD OF THE INVENTION

The present invention relates generally to a method and system for generating new business models in an environment, or ecosystem, of existing business models and customers. More particularly, the present invention describes existing businesses with corresponding business models, simulates the business models to determine their performances, selects one or more of the business models having optimal performance values, and transforms the selected business models to create new businesses.

### BACKGROUND

Research for improving existing businesses is an important area of business management activity. In one typical aspect, this research focuses on improving the operations, and thus the profitability, of a single business acting within a perhaps complex, but usually more or less fixed environment. An example of this aspect of existing research may be found in international patent application PCT/US99/15096, titled “An Adaptive and Reliable System and Method for Operations Management”, filed Jul. 2, 1999, the contents of which are herein incorporated by reference in its entirety.

In another typical aspect, business research focuses on dynamically modeling an entire economic system, as goods and services are exchanged, as new goods and services appear, and as existing goods and services disappear. Such models are particularly directed to guiding businesses in adapting to such economic changes. An example of this aspect of existing research may be found in U.S. Pat. No. 6,125,351, titled “System and Method for the Synthesis of an Economic Web Model and the Identification of New Market Niches”, issued Sep. 26, 2000, the contents of which are herein incorporated by reference in its entirety.

However, the process of creating new businesses and new methods of doing business to meet new business problems has generally been left to human intuition. Often, retrospective and informal study of prior business successes or failures is used to develop “intuition” for guiding future business decisions. But the space of possible business solutions has grown rapidly and combinatorially with the advent of new technologies, new business actors on the now global stage, and so forth. For but one example, complex network effects can lead to surprising and intuitively unexpected results. Human intuition based on past business performance is no longer an adequate guide to future business design.

Therefore, there is an unmet need in the arts of business operations research for methods and systems for generating entirely new business methods in the complex modern environment of existing business methods, technologies, cultures, and so forth.

Citation or identification of any reference in this Section or any section of this application shall not be construed that such reference is available as prior art to the present invention.

### SUMMARY OF THE INVENTION

The present invention satisfies this need in the prior art by providing novel, systematic, and effective methods for finding new business methods that solve particular business problems. Importantly, this invention describes a plurality of initial business models that solve the business problem and then optimizes one or more of these models to find improved and effective solutions to the business problem. These models are preferably described in a generally modular fashion including, each model having a value module, which describes, inter alia, possible goods, services, or other values produced by a business along with their target customers, an operational module, which describes, inter alia, the business inputs and the technology and transformations needed to obtain business outputs, and a revenue module, which describes, inter alia, pricing and cost models, how revenue from operations is obtained, and generally consideration exchanged. Importantly, the descriptions of these components are computer-simulateable, preferably by being described in language appropriate to the business problem at hand, but at least by being described in a regular syntax with determined meanings.

Also importantly, optimization methods used in the present invention operate on the business-model modules. To find improved models from the initial models, models are transformed by altering a module, or by adding a new module, or by removing a module, or so forth. The module description language, or regular syntax, facilitates this interchangeability of the modules. These alterations and changes are preferably guided by those modules and combinations that have proved successful in prior optimization cycles. It is believed that the present invention derives part of its effectiveness because the modular description of business models in terms of modules selected for usefulness to the business problem at hand constrains the potential combinatorial complexity of exploring all business models. In other words, the business heuristics represented by module selection constrains the search without limiting the breadth of possible solutions.

In preferred embodiments, the invention provides a plurality of interchangeable modules, also called building blocks herein, that each describe an elementary aspect of businesses directed to the business problem at hand. Building blocks may be classified into several classes, at least value proposition building blocks, operational arrangement building blocks, and revenue model building blocks. Value proposition building blocks describe a particular output produced by a business, its quality or constraints, its likely customers and the value (utility) of the output to the customers, and so forth. Operational arrangement building blocks describe individual business operations, for example, the technology and infrastructure needed to produce a good or service, inputs to a business for producing the good or service, the transformation of inputs used by the business to produce the good or service, labor and capital required for the transformation, and so forth. Revenue model building blocks describe a business pricing scheme for a good or service, the actual price used in the scheme, costs expended in producing the good or service of the specified quality, the expected revenue, and so forth. This invention may also include other classes of building blocks useful in particular business problems.

Business models are constructed from combinations of the interchangeable building blocks, and a space of business models, in which business solutions to the business problem are found, is defined by all meaningful combinations of the building blocks. It is advantageous for business models to have an associated performance models, which specifies how well the modeled businesses solve the business problem according to a range of metrics. Certain metrics may include financial parameters, such as profit, revenue, and so forth; other metrics may include market parameters, such as market share, market capitalization and so forth. In this embodiment, business models and transformed and optimized by operations on the building blocks. For a particular example, the quality of goods may be a variable of interest in a given business problem. Then, appropriate value proposition building blocks would represent customer value in terms of quality of goods; appropriate operational arrangement building blocks would represent the requirements for producing various qualities of goods; and revenue model building blocks would include pricing quality-dependent schemes. Optimization of business models constructed from these building blocks would then lead to discovery of the optimum quality, or range of qualities, that should be produced for maximum business revenue and customer value.

In further preferred embodiments, a plurality of businesses described by business models are considered together as a business “ecosystem”, in which the business models may interact with each other by exchanging goods, services, and consideration among themselves. Preferably, a business ecosystem also includes customer models, which may select a business model and patronize that models in order to obtain sought-after values (utilities or goods or services). Such a business ecosystem has many advantages in arriving at improved business models. For example, by including customers with a range of preferences and tastes (various utilities), an ecosystem can provide information on market segmentation. As business models strive to satisfy customers generally or specifically, niche or mass markets may be observed. By including business models with business-business awareness or interaction, an ecosystem may provide information on joint business activities. Vertical supply chains, horizontal agreements, and other business alliances and strategic behavior may be observed. Market segmentation and share and strategic relationships (and other business behaviors) may be represented in the building blocks. For example, value proposition building blocks may represent values targeted to specific types of customers, and revenue mechanism building blocks may represent pricing strategies for use against other businesses.

Preferred optimization methods, especially where an ecosystem of business models are described in terms of building blocks, are based on evolutionary or genetic principles. Evolutionary methods generally progress through a number of generations, where a succeeding generation is the product of genetic operators applied to the fittest business models in the immediately preceding generation. Business model fitness is determined by ecosystem simulation, and represents in a single parameter an overall assessment of the model performance. In alternatives, fitness may depend on only a single important performance metric, or may depend on a combination of performance metrics. The applied genetic operators typically model actions occurring among biological organisms, and preferably act on the building blocks, mutating a single building block or exchanging building blocks between business models. Repeated selection and transformation of the fittest models leads to business models of improved performance for solving the business problem at hand as the generations pass.

Additionally, the present invention includes actually applying effective business models as business methods for real-world businesses. Where appropriate, the present invention also includes seeking intellectual property, for example, patent, protection for the generated business models.

This invention also provides systems for performing these methods, and computer software causing the performance of these methods, and computer-readable media on which this software is encoded.

The methods and systems of the present invention can be applied to a wide of business problems. For example, not only can they may generate improved business models in response to the current state of an industry or business ecosystem, they may also discover entirely new business opportunities or entirely new business organizations not readily apparent to those of skill in the arts. In particular, these methods and system may find new ways of capturing value in an existing industry; may update business methods to continually adapt to changing consumer behaviors; may discover opportunities for new technologies. These systems and methods may transform potentially revolutionary technologies into revolutionary new business models that will best capture the value of the new technologies.

These methods and systems may be also used in strategic advisory or consulting services that help actual business to define best strategies or business methods in view of their current position. These advisory service may be of value to financial analysts. Business models discovered may be licensed to entrepreneurs, venture capitalists, and other investors. Further businesses may be spun out or “incubated” by using the invention to develop more successful business models from the building blocks of already successful business models. Indeed, new ways of using the present invention may be discovered by application of the invention itself.

A particular field where this methods and systems of this invention can be especially useful is, without limitation, the Internet economy, or the Internet ecosystem. Here, business methods are often more important than pure technology; typically a large number of business depend on each other's behavior and performance through a web of interactions (ranging from purely financial to technology-based to strategic partnerships, etc); “network” effects and highly nonlinear behavior may produce completely counterintuitive business results. It is likely that some resulting business models may be able to generate large rewards.

The methods and systems of the present invention may have various additional components. For example, they may include an analysis component that is useful to interpret and understand why a particular business model is successful or unsuccessful. Another optional component may be a method for detecting “correlated success” (strategic behavior), that is, business models that exhibit performance only when combined with other business models. In this case, an investor wanting to launch such a business model would then be advised to either seek alliances with the existing synergistic businesses or to help launch synergistic companies. This is a practice more common in Japan, where it is known as kereitsu networks. A further optional component may test business methods for robustness, for example, against perturbations to the ecosystem environment of a given business model. Such perturbations may be the arrival or disappearance of new business methods, may be changing customer tastes, or so forth.

In a first particular embodiment, the present invention includes a method for generating business models for solving a selected business problem comprising: describing a plurality of computer-simulateable business models, wherein a business model describes operations of businesses for solving the business problem, and wherein a business model has an associated operational performance model, determining the operational performances of the businesses described by the plurality of business models by simulating the plurality of business models, and generating a next plurality of business models from the simulated plurality of business models by performing an evolutionary method including applying one or more genetic operators.

Aspects of the first embodiment, include: describing a business-model environment, wherein the business-model environment includes a plurality of computer-simulateable customer models, wherein the customer models patronize the business models to receive values from the business models, and wherein determining the operational performance further includes simulating the environment, including simulating the customer models receiving values from the business models; and evolutionary methods that include (i) determining business-model fitness in dependence on the operational business-model performances, (ii) selecting one or more business models in dependence on their fitness, and (iii) transforming the selected business models into new business models by applying one or more genetic operators, wherein the new business models incorporate elements of the selected business models.

Further aspects of the first embodiment include: genetic operators that include a cross-over operator which transforms at least two parent business models into at least one new business model by combining characteristics of both parent business models into the characteristics of the at least one new business model, and a mutation operator which transforms a parent business model into a new business model by modifying a characteristic of the parent business model; repeating one or more times the steps of determining and generating, wherein each step of determining simulates the plurality of business models resulting from the previous step of generating; a space of business models; and at least two business models that interact, wherein the step of determining further includes simulating interactions between business models.

Still further aspects of the first embodiment include: business models including parameter data specifying the business operations described by the business models; business model descriptions with computer-simulateable value propositions (VP) which describe output values provided by businesses, namely descriptions of the natures of one or more goods or services provided, or qualities of the goods or services, or customers for goods and services, or relations with other business models, or marketing to customers or business models; business model descriptions with computer-simulateable operational approaches (OA) which describe inputs to businesses and transformations of inputs to output values by businesses, namely descriptions of inputs needed for the goods or services provided, or technology employed to produce the goods or services, or capital and labor needed for production; business model descriptions with computer-simulateable revenue mechanisms (RM) which describe pricing and cost models by which businesses acquire revenues, namely descriptions of a margin or an amount per transaction, or per unit time, or per unit volume, or transaction pricing mechanism, or a subscription pricing mechanism, or a flat rate pricing mechanism, or a membership fee pricing mechanism; and business models with descriptions of one or more inputs to a business, one of more values output from a business, one or more transformations of inputs into output values by a business, labor and capital required for a business, and one or more pricing models for a business.

In a second particular embodiment, the invention includes a method for generating business models for solving a selected business problem comprising: describing a plurality of computer-simulateable building blocks, wherein the building blocks include one or more business elements of the business problem, and generating an initial plurality of business models, wherein a business model describes operations of businesses for solving the business problem, and wherein a business model includes a plurality of building blocks and an associated operational performance model, determining the operational performances of the businesses described by the plurality of business models by simulating the plurality of business models, and generating a next plurality of business models from the simulated plurality of business models by performing an evolutionary method, wherein the evolutionary method uses a fitness dependent on the operational business-model performances and applies genetic operators to the building-blocks of business models, and repeating one or more times the steps of determining the operational performance and generating a next plurality of business models, wherein each step of determining simulates that plurality of business models resulting from the previous step of generating.

Aspects of the second embodiment include: computer-simulateable value proposition (VP) building blocks which describe output values provided by businesses, and more particularly describe the natures of one or more goods or services provided, or qualities of the goods or services, or customers for goods and services, or relations with other business models, or marketing to customers or business models; computer-simulateable operational approach (OA) building blocks which describe inputs to businesses and transformations of inputs to output values by businesses, and more particularly describe inputs needed for goods or services provided, or technology employed to produce the goods or services, or capital and labor needed for production; computer-simulateable revenue mechanism (RM) building blocks which describe pricing and cost models by which businesses acquire revenues, and more particularly describe a margin or an amount per transaction, or per unit time, or per unit volume, or transaction pricing mechanism, or a subscription pricing mechanism, or a flat rate pricing mechanism, or a membership fee pricing mechanism; a space of business models for solving the business problem; business elements that describe an input to a business, or a value output from a business, or a transformation employed by a business, or a consideration received by a business for an output value.

Further aspects of the second embodiment include: describing a business-model environment, wherein the business-model environment includes a plurality of computer-simulateable customer models, wherein the customer models patronize the business models to receive values from the business models, and wherein the step of determining operational performances further includes simulating the environment, including simulating the customer models receiving values from the business models; customer models that describe customer behaviors, such as patronizing a business model, choosing a business model to patronize, and being idle; evolutionary methods including determining business-model fitness in dependence on the operational business-model performances, selecting one or more business models in dependence on their fitness, and transforming the selected business models into new business models by applying one or more genetic operators, wherein the new business models incorporate elements of the selected business models; genetic operators including a cross-over operator which transforms at least two parent business models into at least one new business model by selecting building blocks from both parent business models to be the building blocks of the at least one new business model, and a mutation operator which transforms a parent business model into a new business model by modifying a building block of the parent business model; and building blocks that describe only one or more inputs to a business, or only one of more values output from a business, or only one or more transformations of inputs into output values by a business, or only one or more pricing models for a business, or only one or more performances of a business.

In a third particular embodiment, the invention includes a method for generating business models for solving a selected business problem the method comprising: describing a plurality of computer-simulateable building blocks, wherein the building blocks include descriptions of one or more business elements of the business problem, and wherein business elements include descriptions of an input to a business, or a value output from a business, or a transformation employed by a business, or a consideration received by a business for an output value, determining the operational performance of a business described by a business model, wherein a business model includes a plurality of building blocks and an associated operational performance model that describe operation of a business for solving the business problem, and wherein operational performance is determined by simulating the business model, and generating a final business model of improved performance by performing an optimization method, wherein the optimization method (i) uses a fitness dependent on the operational business-model performances, and (ii) substitutes or alters one or more building blocks of the business model.

Aspects of the third embodiment include: describing one or more computer-simulateable customer models, wherein the customer models patronize the business model to receive values from the business model, and wherein determining the operational performance includes simulating the one or more customer models receiving values from the business model; repeating one or more times the steps of determining and generating, wherein each step of determining simulates that business model resulting from the previous step of generating; optimization methods that include an evolutionary optimization method.

Further aspects of the third embodiment include: computer-simulateable value proposition (VP) building blocks which describe output values provided by businesses; computer-simulateable operational approach (OA) building blocks which describe inputs to businesses and transformations of inputs to output values by businesses; and computer-simulateable revenue mechanism (RM) building blocks which describe pricing and cost models by which businesses acquire revenues.

In further particular embodiments, the invention includes computer executable software instructions stored on a computer readable medium, the software instructions for causing a computer to perform the methods of the invention; and a computer system for generating business models for solving a selected business problem comprising: a processor, and a memory accessible to the processor, wherein the memory is configured with software instructions and data for causing the processor to perform the methods of the invention.

### BRIEF DESCRIPTION OF THE DRAWING

The present invention may be understood more fully by reference to the following detailed description of the preferred embodiment, illustrative examples of specific embodiments of the invention and the appended figures in which:

FIG. 1 illustrates an exemplary modular description of business models according to the present invention;

FIG. 2 illustrates exemplary business models according to the present invention;

FIG. 3 illustrates an exemplary description of a space of alternative business models according to the present invention;

FIG. 4 illustrates a business ecosystem according to the present invention;

FIG. 5 illustrates an evolutionary method according to the present invention;

FIG. 6 illustrates exemplary results of one generation of an evolutionary method according to the present invention;

FIG. 7 illustrates the evolutionary cross-over operation according to the present invention;

FIG. 8 illustrates a description of a business-model space for the exemplary internet service provider example of the present invention;

FIG. 9 illustrates an exemplary internet service provider business-model description;

FIG. 10 illustrates an exemplary internet service provider ecosystem;

FIG. 11 illustrates an exemplary state diagram for the internet service provider ecosystem simulation;

FIGS. 12A-B illustrate results for the exemplary internet service provider example of the present invention;

FIG. 13 illustrates an exemplary system for practicing the present invention; and

FIG. 14 illustrates the general method of the present invention.

### DETAILED DESCRIPTION OF THE PREFERRED EMBODIMENT

The methods and systems of the present invention generate business models that effectively solve certain business problems. Generally, these methods, first, systematically describe a range, or space, of possible business models applicable to a particular business problem, and, second, methodically seek final business models in the described space that rank highly according to selected criteria (i.e., are highly fit). Computer systems of the present invention include computer code, or instructions, that perform these methods.

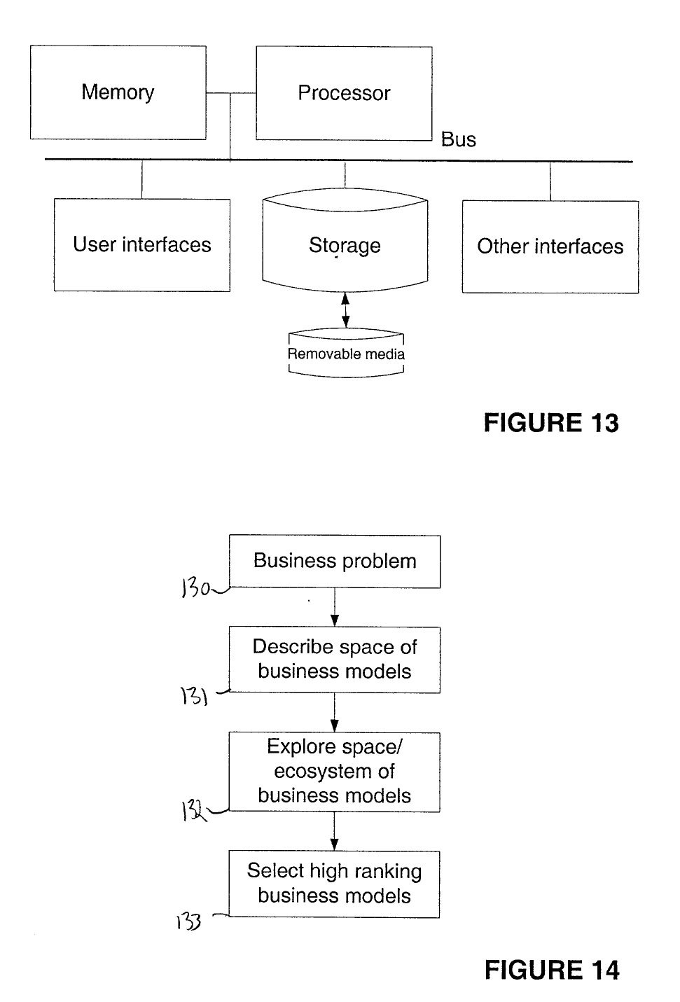

First, the preferred embodiments are generally described with respect to FIG. 14. The present invention starts with and solves a give business problem (step 130 in FIG. 14). Alternatively, a business problem defines a particular application of the methods and systems of this invention. Generally, a business problem is broadly understood to relate to businesses and their customers. More specifically, a business problems includes customers who have needs, requirements, tastes, and so forth. It also includes businesses directed to meeting customer needs, by, for example, addressing how to provide new goods or services, or how to provide existing goods or services in new ways, or how to respond to changing business environments, or how to combine or organize business for increased performance, or so forth. A business problem may also address how to meet changes in customers, their numbers, needs, tastes, or so forth. The possible arrangements of the customers and businesses is also broadly understood in a business problem. For example, all businesses may supply value to customers, or only some businesses may supply customers while other businesses may supply only businesses, or customers may simply be a subset of the businesses, or so forth.

A business problem also generally relates to supplying particular goods, providing particular services, or offering particular values. By way of illustration, a business problem related to Internet services may be concerned only with the actual service provider businesses, and perhaps their customers. But it is not necessarily so limited, such a business problem may also be concerned with the suppliers of communications services used by the Internet services providers; it may also be concerned with provides or Internet content, or with Internet retailers; it may be concerned with competitive media such as TV and newspapers. In other words, although business problems may be focused on certain goods or services, it may include consideration of suppliers or complementary or competitive goods (economically related businesses), or of the suppliers of inputs for the actual goods or services (physically related businesses), or with other business physically or economically related to the focus in other manners.

A business model, which described as business, is also broadly understood. It is a description in sufficiently precise and complete detail of performing a business that solves the business problem so that it is also to computer simulation. Preferably, a business model description may be structured as a combination of individual business elements, where a business element describes an individual aspect of a business. Business aspects may include outputs from modeled businesses provided to external businesses or customers, inputs to modeled businesses, internal transformations performed by modeled businesses, and quantitative assessments of performance of modeled businesses. In more detail, an individual element may describe an input necessary to the business, an output from the business (or a value provided by the business), a transformation between inputs and outputs, a capital item required or an amount of labor employed by the business for transforming inputs to outputs, a pricing or similar plan for recovering rewards from values produced, a financial model of the business's performance, and so forth. Importantly, the business elements and their relationships must representable in a computer program so that the functioning of the described business model can be simulated. In other words, business model descriptions need to be computer simulateable. Equally importantly, each building block of a business model must represent a stand-alone module that is autonomous from but connected to other modules in such a way that the resulting business model can be recombined (according to genetic search methods) using the modules as the units of recombination. In other words, the encoding of business models through the use of building blocks must thereby allow business models to be evolvable to facilitate searches through the space of business models.

Therefore, preferred representations of building blocks are those suitable for genetic and evolutionary search methods. Such representations are known in the art. See, e.g., Michalewicz, 1996, Genetic Algorithms+Data Structures=Evolution Programs, Springer Verlag (ISBN 3540606769); and Banzhaf et al., 1998, Genetic Programming: An Introduction: On the Automatic Evolution of Computer Programs and Its Applications, Morgan Kaufmann Publishers (ISBN 155860510X).

Then, in a next step, the methods of this invention describe a range, or space, of business models (step 131 in FIG. 14) any of which may solve the business problem at hand. The one or more final business models output by these methods are highly-ranked business models found in this described space. A range, or space, of business models, according to the present invention, is preferably described in a modular and combinatorial fashion by providing a plurality of alternative building-blocks, which can be interchangeably joined and linked to describe a business model. Generally, building blocks are packages of one or more of the related business elements (or for one or more groups of elements) that may be part of a business model description. Building blocks are interchangeable in a business model when one building block may be substituted for another related building block with little of no disturbance to other building blocks present in the model. For example, a business model may change is pricing scheme and mechanism by simply changing a building block. Interchangeability is promoted when the business elements packaged in a building block, and the relations of these elements to other elements that may be part of a business model, are described in a standardized fashion. For example, where a business produces two types of values, a good and a service for that good, its business model may have one building block with elements describing the good and another building block describing the service. Similarly, where a business sells a good with two different pricing models to two different classes of customers, its business model may have separate building blocks describing each pricing model. Importantly, building blocks in the present invention can be simulated by a computer program, especially because the package simulateable elements.

According to an analogy, building blocks, which may be interchangeably combined to describe business models, are similar to programming objects, which may be interchangeably combined to create programs, and the elements packaged in the building blocks are similar to the methods and data packaged in program objects. Also, as program objects are advantageously standardized for constructing particular types of programs, building blocks, in preferred embodiments described subsequently, are advantageously standardized for describing business models generally, as well as for describing aspects of particular business problems.

In this step, customers for the businesses are also preferably described in a computer-simulateable manner. Customer descriptions include, at least, elements describing the values sought, specifically, the goods and services desired along with indications of quantities, qualities, acceptable constraints, and other terms relevant to the business problem at hand. Customer description may further include means and indicia by which customers chose particular business models to patronize for goods and services. In one embodiment, customer descriptions are structured to describe that a customer may be in one or several states, for example, an idle state, choosing a business model, patronizing a business model, and so forth, and may make transitions between states in response to certain events. These states and transitions may be parameterized in order to describe a range of customers. Alternatively, customers may simply be certain business models that obtain goods and services from other business models, and that are described simply as business models. Further, but less preferred, no customers of any type may be present. Generally, customers are considered herein as part of an environment, which may include such further entities (such as “suppliers”) necessary to an ecosystem and its interactions.

In a next step, the methods of the present invention methodically explore (step 132 in FIG. 14) the described space of business models, seeking final business models in the described space that rank highly according to selected business criteria. Although the invention employ preferred competitive, or “evolutionary”, methods according to which final business models are those which survive simulated competition, this invention is not so limited and may also employ other known optimization techniques. Such techniques are those that exhaustively or heuristically explore the space of business models, and include, for example, local search heuristics, simulated annealing, reinforcement learning, adaptive computation and machine learning, and other similar techniques known in the art. See, e.g., Rardin, 1997, Optimization in Operations Research, Prentice Hall (ISBN 0023984155); Johnson ed., 1989, Simulated Annealing and Optimization: Modern Algorithms With VLSI, Optimal Design, and Missile Defense Applications, American Sciences Press (ISBN 0935950184); and Sutton et al., 1998, Reinforcement Learning: An Introduction, MIT Press (ISBN 0262193981).

The remainder of this description is primarily focused on the preferred evolutionary techniques, which simply and naturally permit consideration business ecosystems. Evolutionary techniques include genetic algorithms, evolution algorithms, genetic programming, evolutionary programming, and so forth. See, e.g., Back et al. eds., 1997, Handbook of Evolutionary Computation, Institute of Physics Publishing (ISBN 0750303921); Michalewicz, 1996, Genetic Algorithms+Data Structures=Evolution Programs, Springer Verlag (ISBN 3540606769); and Banzhaf et al., 1998, Genetic Programming: An Introduction: On the Automatic Evolution of Computer Programs and Its Applications, Morgan Kaufmann Publishers (ISBN 155860510X).

In these preferred evolutionary techniques, competition is simulated by a plurality of business models and relevant aspects of their environment, such as their customers and suppliers. Customers choose business models and receive values from the chosen models according to their customer description, while business models compete for customers and supply values to their customers according to their models. The business and their models are referred to herein as a business “ecosystem” (or simply as an “ecosystem”). Evolutionary methods, therefore, generate business models optimized according to their performance in a realistic business and economic environment, instead of in isolation where the effects of competition must be guessed at.

A business ecosystem includes not only business models and optionally customers and suppliers, but may also include interactions between these entities, especially between business models. These interactions include the supplying of values (such as goods and services) from one of these entities to another of these entities, as well as the receiving of rewards or consideration (such as money payments) in return. In one embodiment, these interactions can be automatically or dynamically set up in an ecosystem. For example, by virtue of standardized descriptions, a customer or business model seeking a good described as “good X” may obtain such a good from any business model having a building block supplying “good X”. An ecosystem may include a model market in “good X”, which acts as a central clearing point for all entities supplying or seeking “good X”. A different ecosystem may include behaviors by which one business model may choose another as its supplier of “good X” as well as elements describing long term supply arrangements for “good X”. In further ecosystem, these interactions may be manually (or quasi-manually) established once for given round of simulation. In this case, a customer of “good X” may be for the duration of the round permanently linked to one or more business models offering “good X”.

Final business models are selected (step 133 in FIG. 14) according to the results of this simulated competition (or other optimization technique). Ecosystem simulation may be done by many convenient known simulation techniques or combination thereof, including discrete-event simulation, agent-based and multi-agent-based simulation, system dynamics simulation, equation-based simulation (see references below). See, e.g., Banks ed., 1998, Handbook of Simulation: Principles. Methodology, Advances, Applications. and Practice, John Wiley & Sons (ISBN 0471134031); Zeigler et al., 2000, Theory of Modeling and Simulation: Integrating Discrete Event and Continuous Complex Dynamic Systems, Academic Press (ISBN 0127784551); Banks, 1995, Discrete-Event System Simulation, Prentice Hall (ISBN 0132174499); Moss et al., 2001, Lecture Notes in Computer Science, 19 (Multi-Agent-Based Simulation: Second International Workshop, MABS 2000, Boston, Mass.), Springer Verlag (ISBN 354041522X).

Business model selection criteria (fitness) may be profit, revenue, market share, value creation, or other business measures observed after a certain period of simulation. Value creation may depend not only on a business model itself but also on its interactions with the other business models in an ecosystem. Further criteria may depend on the performance of business models over a period of time. Several aspects of the time-behavior of business models may available from the dynamic and competitive evolution of business models, according to which business-model performance is evaluated as the business method and its industry environment mutually interact and as new business models appear and former models disappear. For example, one such criteria may be robustness, by having limited down-side risks while being adaptable to exploit up-side advantages.

Business models selected according to the present invention have numerous uses, some of which are described above. For example, they may be implemented in new or existing real-world businesses. It may be preferably, in advance of implementation, to express the models as patentable subject matter, for example, as patentable business methods, and to seek patent protection for the business models to be implemented.

Next, preferred embodiments of the methods of this invention are described in detail, followed by consideration of systems for implementing these methods. In a subsequent sub-section, the present invention is applied to the business problem of providing internet access services.

### The Methods of the Present Invention

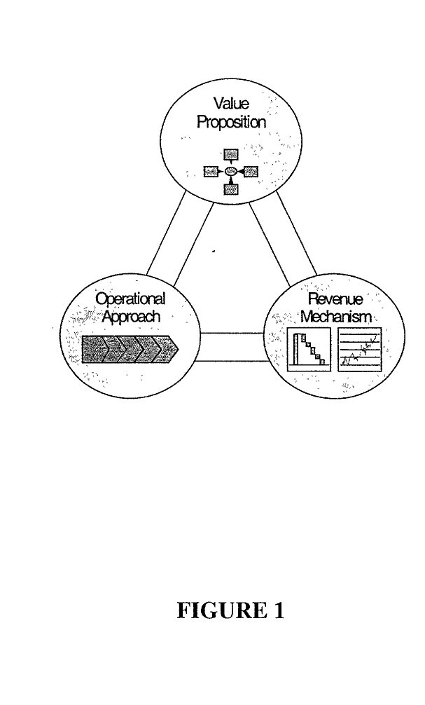

FIG. 1 illustrates the present invention's preferred modular description of business models, according to which a model includes one or more of the following building blocks: a value proposition (“VP”) bulding block, an operational approach (“OA”) bulding block, and a revenue mechanism (“RM”) bulding block.

Briefly, a VP describes the values provided by certain goods and services from the customer's (individual or business) perspective. Therefore, a VP may include parameters describing the following:

Types of the goods or services, that is outputs;

Details of the goods or services, such as their quality;

Constraints on the goods or services;

Values or utility of the goods or services;

Possible customers; and so forth.

An OA describes the mechanisms and requirements for providing or delivering particular goods and services. An OA may include parameters describing:

Capital required, such as the type and number of machines for a unit of a good or a service;

Labor required, such as the type and amount people for a unit of a good or a service;

Other infrastructure and technology required to provide or deliver goods or services;

Raw materials required, that is inputs for the outputs;

Suppliers of inputs and infrastructure; and so forth.

Finally, a RM describes financial results of offering the VP to customers, or alternatively, the consideration received from customers (or other business models). A RM may include parameters describing:

Pricing model, such as the transaction type, flat rate, subscription rate, membership fees, quantity discounts, good customer discounts, etc.;

Price actually charged per unit of goods or services;

Pricing strategies, such as “lower cost to achieve pre-determined market share”, “charge the average industry price”, or so forth;

Marketing strategy and costs;

Acceptable and target margins; and so forth.

These listed parameters are merely exemplary; fewer, more, or different parameters may be advantageous for various business problems. Additionally, the representation need not be parameterized, or “data driven” (for example, as abstract data types); instead it may be procedural or object-oriented or by another programming paradigm as known in the arts. Even more, this particular description in terms of VP, OA, and RM building blocks is not limiting, as it will be apparent to one of skill in the art how to adapt the preferred embodiment to other modular descriptions of business models.

As FIG. 1 further illustrates, a VP, an OA, and a RM interact to describe the overall functioning of a business model. For example, the VP together with the OA determine the input required for the output goods or services; the VP together with the RM determine the revenue from the goods or services sold; and the OA together with the RM determine the cost of the goods or service sold. These interactions may be explicitly specified in advance of the simulation program, or inferred by a simulation program from the descriptive conventions (or description language)

However represented—as parameterized data structures, or as objects, or according to another paradigm—the VP, OA, and RM building blocks must be sufficiently precise and definite so the they may be input to a computer simulation program. For example, in a data-driven representation, for specifying one or more of a set of items (for example, individual goods and services), a enumerated data type may be used; for specifying input-output relationships, an input-output matrix may be used; for pricing models, a set of pricing functions may be provided; and so forth. Corresponding possibilities for other parameters will be immediately apparent to those of skill in the art. When parameters are consistently specified as described, then the building-block descriptions may be immediately amenable to use by a simulation program, for example, by permitting inference of relationships.

Such consistent description may be considered a form of “language” (in the sense used in the computer arts, meaning a standardized syntax for specifying a controlled semantics). In a further preferred embodiment, the description language is more formalized by providing a hierarchy of descriptive elements adapted to described business models generally, or perhaps specifically business models for a particular business problem. Developing syntax and semantics for computer languages, especially for descriptive languages, is well known in the computer arts, and one of skill may readily develop such descriptive business-model languages, at least those based on value proposition, operational approach, and revenue mechanism building-blocks, in view of the description above. Such a language is advantageous because it allows the formalization of the value creation processes in a natural way for a particular business problem. The special language permits the description of a given business model as a specific combination of building blocks or elementary units. Businesses in a given industry, as well as interactions among them, are preferably described using such a special language.

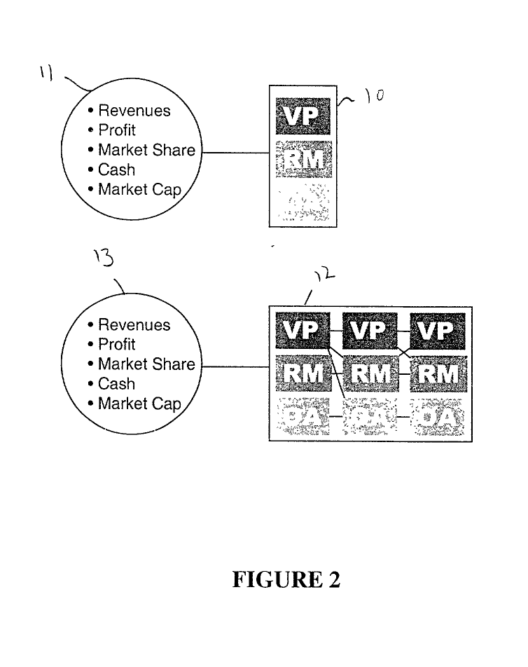

FIG. 2 illustrates further details of business models described in the preferred modular manner. Here, a simplest instance of a preferred business model is model 10 including a single VP building block, a single RM building block, and a single OA building block. This model, as is also preferred, has an attached performance model, illustrated here as financial model 11. Generally, performance models include at least one or more variables representing information useful for evaluating the chosen business-model fitness or selection criteria. The information represented may relate, for example, to a current status of the business model, or to running averages of previously current statuses, or to other measures of the time variability of the business model, or so forth. These variables may be updated during the simulation of the business model according to the business-model building blocks. For example, gross revenue may be obtained from the RM and VP building blocks; costs from the OA building block; and revenue by routine calculation.

Preferred performance models, illustrated as models 11 and 13, include a financial model constructed according to standard accounting principles. For example, a financial model may include variables relating to a revenue statement, such as net revenues, profits, and so forth, as well as variables relating to an asset and liability statement, such as current cash and cash equivalents. Additionally, preferred performance models include some measure of the market success of a business model separate from pure financial numbers. A basic measure is market share measured with respect to the population of competitively evolving business models. Another measure is market capitalization, which may be available if a stock market model is included in the business ecosystem.

Business models are not limited to simple model 10, but, as illustrated by model 12, may be more complex. One single business model may have several, possibly partly interdependent, building blocks of a single type or types. For example, model 12 has three VPs, RMs, and OAs. These building blocks have interdependencies indicated by lines between blocks, which may be inferred or manually specified.

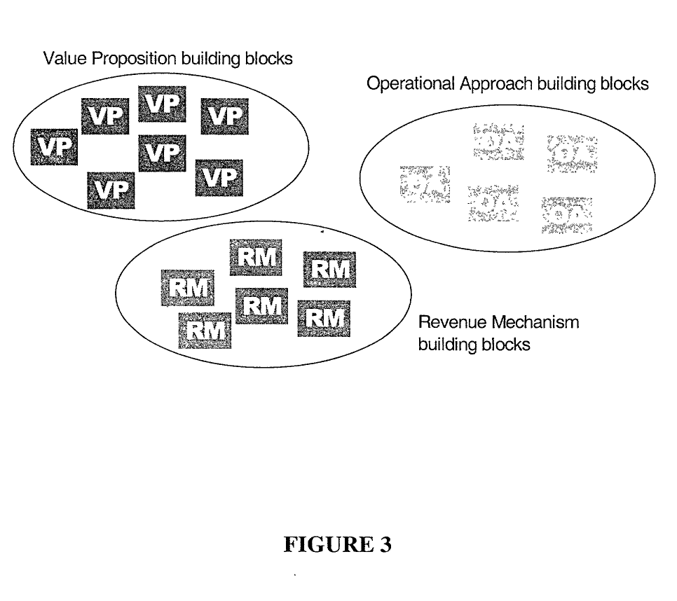

FIG. 3 (in conjunction with FIG. 2) illustrates an exemplary description of a space of business models. A space description begins with a plurality of alternative building block descriptions directed to the particular business problem at hand. Thus, FIG. 3 illustrates several VP building blocks, several OA building blocks, and several RM building blocks. A space description is completed upon joining the alternative building blocks in different combinations to form alternative business models. Such joining is possible because they are described in a modular fashion according to a more or less formalized description language. Thus, FIG. 2 illustrates two exemplary business models, models 10 and 12, which may include one or more building blocks from each of the types of building blocks illustrated in FIG. 3. In this manner, it is apparent that a space description provides a space of business models approaching combinatorial complexity and variability.

Having provided a description of a preferably combinatorial space of business models directed to the business problem at hand, the present invention next explores this space seeking final business models that rank highly according to selected performance criteria. Although the present invention may explore this space by focusing on one business model at a time using known optimization techniques, in preferred embodiments this space is populated by a plurality of interacting and competing business models which jointly explore this space in the context of simulated economic competition. The interacting and competing business are referred to herein as a business “ecosystem”.

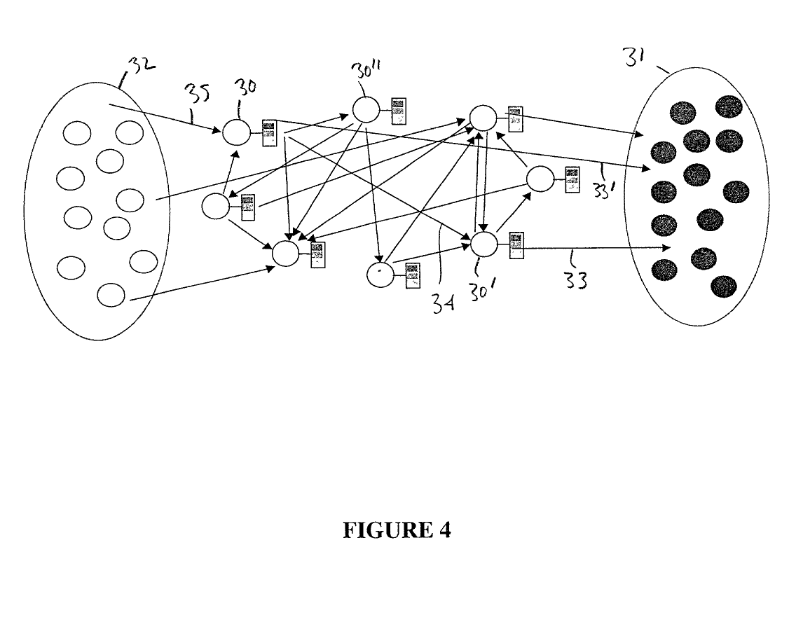

FIG. 4 illustrates an exemplary business ecosystem built from the space of alternative business models already illustrated with respect to FIGS. 2 and 3. The illustrated ecosystem includes a plurality of business models, such as models 30, 30′, and 30″, and interacts both with a plurality of external customers 31 and a plurality of external suppliers 32. The business models, for simplicity and without limitation, are illustrated as simple business model having only a single building block of each type coupled to a performance model. More complex business models may be included in alternative ecosystems. Additionally where appropriate to the business problem, alternative ecosystems may include only business models and customers, or business models and suppliers, or business models alone.

Business models in an ecosystem may mutually interact in a number of ways, primarily determined by their VP and OA building blocks but limited as follows. Generally, VP blocks specify output goods and services from a business model, while the OA blocks specify input goods and services. In a functioning ecosystem, the only net “sources” of inputs are from its suppliers, while the only net “sinks” of outputs are to its customers. Otherwise, all outputs must link with all inputs (at least in the average over reasonable time periods). Where the number of business models of each type in an ecosystem is fixed, these limitations can be established once for all during a simulation. But where business models may fail or may be created, these limitation are established from time to time by the simulation system itself, either as model-to-model links, or as an internal “market”, or by other simulation means. A uniform model description, such as a model description language, facilitates the automatic determination of these links.

FIG. 4 illustrates these various mutual relationships of business model in an ecosystem in more detail. For example, business model 30 receives input goods or services 35 from suppliers 32 and provides output goods or services 33′to customers 31. This model also provides (or receives) goods or services 34 to model 30′. On the other hand, business model 30′only receives inputs from other business models, such as model 30, and not directly from any suppliers. It provides output goods or services 33 to the customers. Business model 30″, alternatively, interacts only with other business models, and not with the external suppliers of customers. Alternatively, the inputs and outputs of each good or service may converge on a modeled internal market for that good or service. Although, the arrows in FIG. 4 have been described in terms of the exchange of goods and services, it is to be understood that accompanying any such exchange in an exchange of consideration, preferably money. This consideration may be directly or indirectly exchanged by the business models engaging in an exchange of goods or services, and is reflected in the accompanying financial performance models.

In summary, the diversity of the inputs and outputs specified in the VP and OA building blocks determine the possible mutual complexity of the business model interconnections. FIG. 4 illustrates a more complex interconnection. Here, the inputs and outputs in the building blocks of the space of alternative business models overlap, so that one business model may be a supplier/customer of another. A more simple “single-layer” of business models between suppliers and customer may be specified by building blocks specifying inputs and outputs which do not overlap. Further, there may be several instances of a single business model in an ecosystem.

In order to complete a description of the ecosystem, it is preferable to provide reasonable models of customers and suppliers to supplement the previously described business models. Customer models preferably represent expected behaviors in response to goods and services, and their quality, constraints, and other modifications, offered by the competing business models. In one embodiment, customers or users may be modeled as computational agents acting according to behavioral profiles appropriate and relevant to the ecosystem modeled. The profiles may be defined by characteristics generally grouped into categories of behaviors, decision metrics, and parameters. The behaviors preferably include decisions about which business models to patronize, about the use of goods and consumption of services offered by the business models, about quality and constraints of the goods and services, about price sensitivity, and so forth. The decision metrics preferably include functions or procedures used for making decisions, selections, and so forth. The behaviors and decision metrics are parameterized by the parameters in such a manner to realize a population of customers of realistic diversity.

In alternative embodiment, customers may be modeled by finite state machines, petri nets, or the equivalent. In such a model, a customer has certain states of activity, such as idle, deciding on business model to patronize, deciding on amounts of goods and services to consume, consuming goods and services, and so forth, with transitions between states determined by decision metrics. Activities in the states and the decision metrics may be parameterized to realize a population of customers.

Suppliers in many ecosystems have a subsidiary importance, and may be modeled accordingly. For example, suppliers may simply supply requested goods or services at fixed prices with fixed terms, or may supply goods or services according to supply curves differentiated according to the supply terms and conditions of the goods or services. Where suppliers are of more importance, they can be modeled similarly to customers.

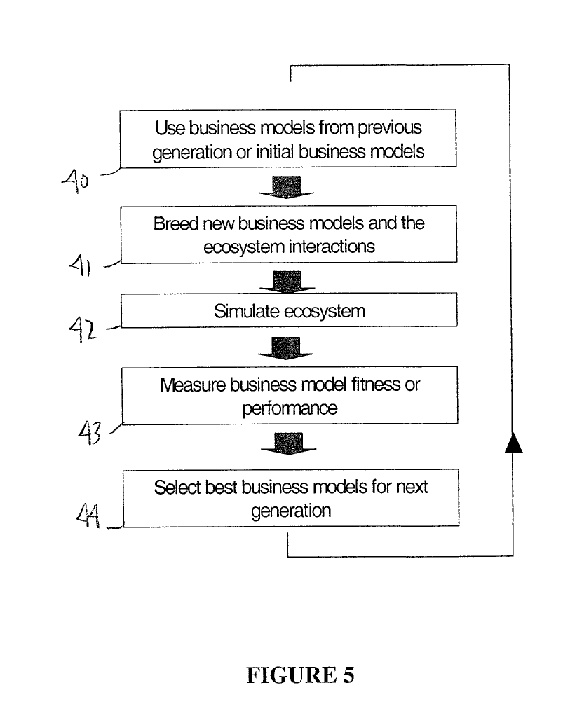

Turning from the construction and completion of an ecosystem description appropriate to the business problem, the methods of the present invention seek business models that will be highly ranked in this ecosystem according to their associated performance models. In preferred embodiments, the present invention uses an evolutionary method to evolve the population of business models in an ecosystems in order seek highly ranked models. See, e.g., Michalewicz, 1996, Genetic Algorithms+Data Structures=Evolutionary Programs, Springer-Verlag, Berlin (included herein by reference in its entirety for all purposes). Evolutionary methods generally proceed as a sequence of “generations”, and FIG. 5 illustrates one generation of an evolutionary method as applied in preferred embodiments. Each generation begins 40 with an ecosystem constructed from an initial set of business models or from the business models resulting from the previous generation. An initial set of business models may be simply constructed as random combinations of appropriate building blocks defining the business-model space. Alternatively, initial models may be those initially predicted to be most highly ranked, perhaps using information from prior simulations or from actual business experiences.

Next new business models are “bred” 41 from the starting business models by using evolutionary operators, including, at least, mutation and cross-over. In the first generation starting from initially determined business models, the breeding step may be skipped. Mutation and cross-over mimic to some degree the corresponding operations in the genetics of biological organisms. Specifically, mutation alters a single aspect of a business model. As applied in the present invention, a mutation may alter a single aspect of one of the building blocks of a business model; specifically, a mutation may alter a single building-block parameter according to a determined probability distribution likely to characterize the altered parameter. Alternatively, a mutation may simple change one bit of a parameter from “1” to “0”, or vice versa.

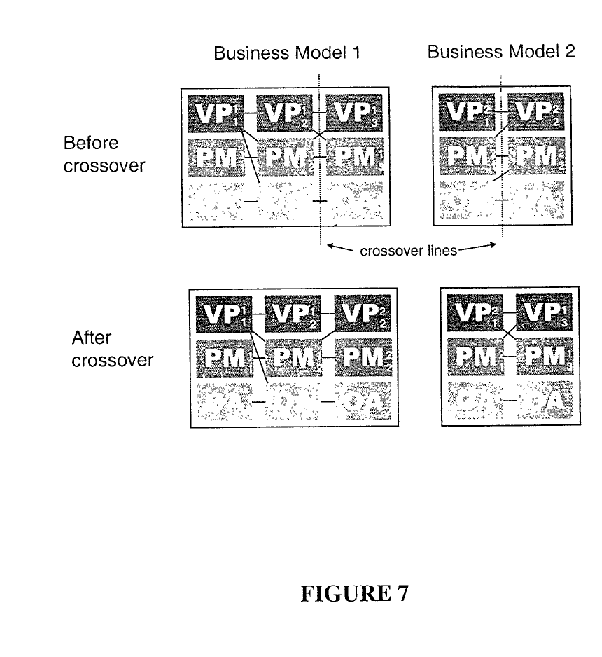

Cross-over, illustrated in an exemplary manner in FIG. 7, exchanges aspects of two separate parental business methods into offspring, or children, business methods, thereby exploring new regions of the business model space. The aspects exchanged between business models are preferably one or more building blocks. In FIG. 7, before crossover, business model 1 includes building blocks VP₁₁ . . . OA₁₃ and model 2 includes building blocks VP₂₁ . . . OA₂₂. (The performance models associated with these models are not illustrated for simplicity.) The illustrated cross-over operation exchanges building blocks VP₁₃ . . . OA₁₃ of block 1 with VP₂₁ . . . OA₂₁, of block 2. Consequently, after exchange, business model 1 includes building blocks VP₁₁ . . . OA₁₂ and VP₂₁ . . . OA₂₁, while and model 2 includes building blocks VP₂₁ . . . OA₂₁ and VP₁₃ . . . OA₁₃. After cross-ever, the offspring building-block children are presumably new business models not yet considered. Cross-over exchanges may also occur at a finer granularity, such as exchange of portions of one or more building-block. This may be done by exchanging sub-sets of parameters between building blocks (where each building block including a set of parameterized quantitative or qualitative characteristics).

This invention may also include further evolutionary operators known in the art, such as recombination.

Returning again to FIG. 5, after new business models are bred and after the goods, services, and financials links in the ecosystem established, the ecosystem is simulated 42. The preferred technical implementation for simulating the customers is agent-based simulation. See, e.g., Ferber, 1995, Multi-Agent Systems, Addison-Wesley Longman, Harlow, England (incorporated by reference herein in its entirety for all purposes). Others of the many simulation methods well known in the art may also be used in this invention.

Generally, the ecosystem simulation includes simulating the businesses of each of the business models in the ecosystem according to their building-block descriptions, as well as simulating customer (and, optionally, also supplier) behaviors. Therefore, goods and services and exchanged among all actors in the ecosystem, and consideration, in particular, money, is exchanged in return. As the business of each model is simulated, its associated performance model is updated with the results of its transactions. When the performance model includes financial information, current and historical profits, revenues, costs, and so forth become available. Further, the simulation can maintain global information about the “macro-economy” of the ecosystem, which may include the total markets in the various goods and service exchanged, gross and net ecosystem product, and so forth. Optionally, a market in the securities of some or all business models may be additionally modeled. In view of model-maintained macro-information, performance models of individual business model may include such additional current and historical data as market share, market capitalization, and so forth.

After a certain simulated period of ecosystem economic activity, the performance models of the simulated business models are examined 43. For example, certain models may have become profitable, certain may have gained market share, while others may have lost money or have seen a declining market share, or so forth. Some business models are expected to perform better than others in terms of revenues, profit, cash on hand, market share, market capitalization, and so forth. Preferably, model performance measures that are important to the business problem at hand are combined into an overall measure of business model fitness which may be used to rank the simulated models. The ranking may be simply by a linear scale, or, alternatively, more complex rankings, such as lattice-based rankings may be used.

From the ranked models, the best are selected 44 to be input to the next generation of the evolution method. Poorly performing business models gradually lose out and are replaced with mutated models and with crossed-over combinations of previous models that are highly ranked. After a number of generations, increasingly successful and highly ranked instances of business models emerge in the ecosystem. In certain embodiments, the change in business model ranking may be observed over simulation generations, and the simulation stopped when no further improvement, or insufficiently rapid improvement, is observed. In other embodiments, the number of simulation generations may be fixed in advance.

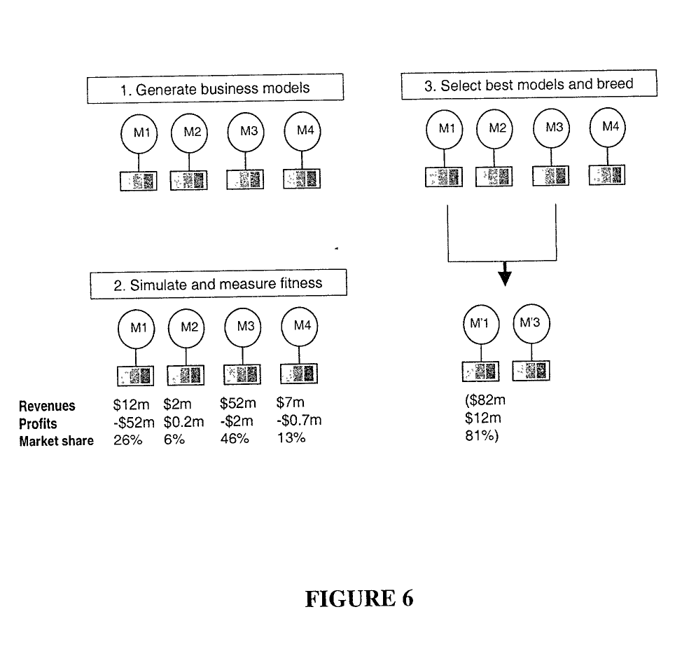

FIG. 6 schematically illustrates a generation of this evolutionary method for a population of four business models—M1, M2, M3, and M4—which are illustrated as a single VA, OA, and RM building block along with a financial performance model. At situation 1, the four business models are about to begin their next generation. At situation 2, a period of simulation is complete, and the financial performances portrayed. For simplicity and without limitation, the fitness of these models is determined only by their revenue, according to which M1 and M3 and the more fit. For the next generation, the most fit business models M1 and M3 are selected for cross-over, resulting in children M′1 and M′3, which then enter the next generation of the simulation. As parenthetically illustrated, child model M′1 demonstrates highly ranked performance in the next generation, and is indeed superior in all measures of revenue, profits, and market share.

In this preferred method, business model performance is context, or ecosystem, dependent. For example, the success of any model depends on which other business method instances are present in the ecosystem, how the ecosystem is structured (who interacts with whom), customer behaviors, and so forth. All of this ecosystem environment may be modeled and evolved. Alternatively, part of the ecosystem environment may be kept constant with no breeding or other evolutionary changes, while the remaining business are evolved in order to generate business methods that are successful in the fixed environment.

### The Systems of the Present Invention

The methods of the present invention may be coded into instructions for causing a computer processor to perform these methods by means of a wide variety of computer languages. Simply, the methods may be coded in conventional procedural languages, such as C. Procedural modules may be supplemented by specialized modules created by specialized languages directed to coding simulation systems, to interpreting/compiling business model descriptive languages, to mathematical computations, and so forth as one of skill in the art will understand. One special purpose language and package advantageously used in the present invention is the MATLAB package (The Mathworks, Inc., Natick, Mass.). The coded instructions may then be loaded into a computer by means of a computer readable media or over a network.

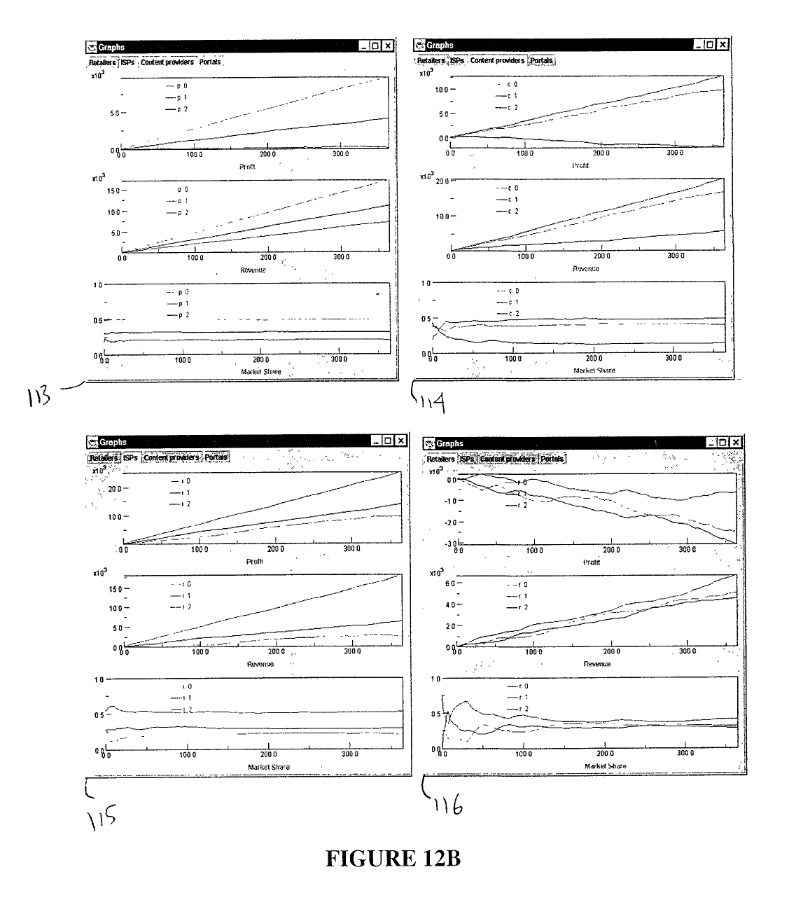

The coded methods may be executed on a sufficiently powerful PC-type or workstation-type, or other type, of computer. FIG. 13 illustrates an exemplary computer with standard components for performing the methods of this inventions. Here, the coded instructions loaded into the memory causes the processor to perform these methods under direction of a user at the user interfaces. Ecosystem results may be stored in the permanent storage.

### INTERNET SERVICE PROVIDER ECOSYSTEM

The methods and systems of the present invention have been applied to describe, model and evolve an internet service provider (“ISP”) ecosystem. An overview of an exemplary model description is presented next, followed by a description of an actually implemented model.

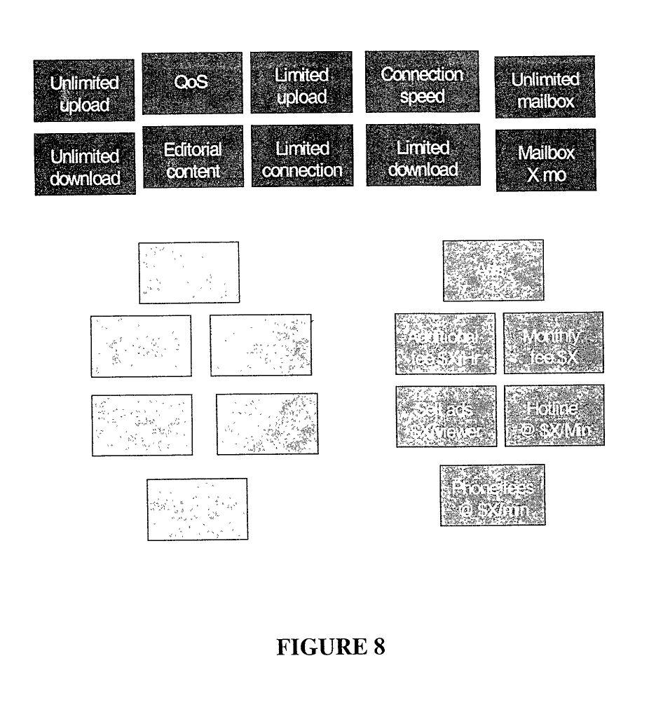

FIG. 8 illustrates possible building blocks for describing a business-model space for ISPs. These building blocks may include the following VP-type building blocks:

Connection speeds available;

Editorial content presented or not;

Limited connection times;

Limited user downloads;

Limited user uploads;

Mailbox usage limited to X messages per month;

Mailbox usage unlimited;

Quality of service (QoS);

Unlimited user downloads; and

Unlimited user uploads.

Each of these building blocks represents a possible value offered to the user, in this example, a particular ISP service option. These VP-type building blocks advantageously include boolean or numeric parameters representing, for example, the availability and limitations, respectively, on the services provided. VP-type building blocks are illustrated in the upper portion of FIG. 8.

The following OA-type building blocks may be included:

ADSL (asymmetric digital subscriber line) access requirements;

Cable access requirements;

Connection hours to be provided in total to all users;

Phone access requirements;

Usage limitations on access methods; and

Server requirements parameterized by number of users per server (for example, 1 server for every 200,000 users).

Each of these building blocks represents an input needed to provide the ISP services offered by the VP-type blocks. These OA-type building blocks advantageously include boolean or numeric parameters representing, for example, the required inputs per unit of value provided. OA-type building blocks are illustrated in the lower left portion of FIG. 8.

The following RM-type building blocks may be included:

Additional per connect-hour fees;

Ads (advertisements) presented to users or not;

Hotline fees for access to special helpline;

Monthly flat fee;

Phone fees per minute for phone connections; and

Sell ads for a fee per ad per viewer.

Each of the building blocks represents a revenue option that an ISP may receive for providing ISP services offered by the VP-type blocks. These RM-type building blocks advantageously include boolean or numeric parameters representing, for example, the value received for the services and service combinations provided. RM-type building blocks are illustrated in the lower right portion of FIG. 8.

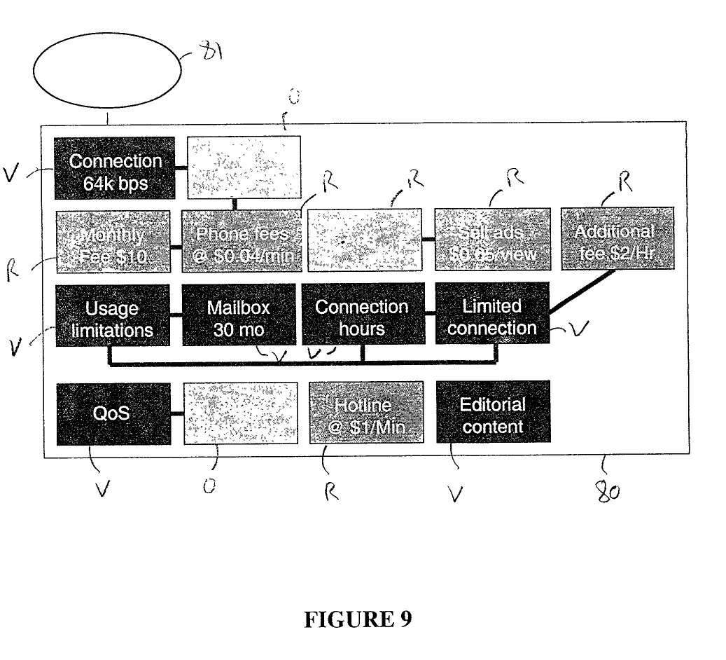

FIG. 9 illustrates an example of particular ISP business model 80 created in the business-model space described by building blocks of FIG. 8. Performance model 81 is associated with this model; blocks labeled with “v” (and with “o” and “r”) are VP-type (and OA-type and RM-type, respectively) building blocks. The interconnections illustrated represent the following interactions among the model building blocks. A offered value of a 64 kbps connection requires phone-line access facilities and returns revenues of a monthly user fee and an incremental per-minute phone line usage fee. Available advertisements require no additional (modeled) resources and return an incremental per-view fee. For a certain additional hourly (or monthly) fee, users receive several additional connection values, such as usage limitations, mailboxes, limited/unlimited connection time, and so forth. A particular quality of service requires certain server resources but returns no additional fee, being typically part of user expectations of the value of the monthly fee. This particular model is exemplary, and numerous other combinations of values, required resources, and revenue returned can be modeled in the described space. In additions, the parameters of this model may be varied to create additional different models.

A customer model appropriate for an ISP ecosystem preferably includes behaviors and parameters relevant to choice of an ISP and to internet access by use of a chosen ISP. For example, a customer model may include the following parameters, behaviors, and decision metrics.

Parameters:

Hours of connection per month;

Connection types used;

Typical internet session length;

Sensitivity to quality of service, for example, response time;

Attitude to unsolicited advertisements;

Probability of clicking-through advertisements;

E-mail usage in messages per month;

Mailbox size in messages; and

Download characteristics, for example, file sizes and number of files;

Behaviors:

Customer logs on to ISP;

Customer logs off from ISP;

Customer complains if service is slow; and

Customer decides to switch ISPs;

Decision Metrics:

Factors determining how a customer chooses a particular ISP;

Prediction Formula;

Weighting of desired values from a ISP;

Factors determining how a customer decides to switch ISPs

These behaviors carried out according to the decision metrics and parameterized with a range of parameter values then model a plurality of typical customers for ISP services provided by the ISP ecosystem.

Additionally, with an appropriately defined extended space of building blocks and resulting business models, the resulting ISP ecosystem may be extended to include, as well as simply ISPs, internet portals, which seek internet user traffic by presenting, abstracting, and aggregating content, content providers, which provide particular types of content in-depth, and internet retailers, which sell goods or services to customers “arriving” from ISPs or portals. Such an extended ecosystem may model business situations where ISP success may depend on relationships with portals and content providers as well as on its own offered value. Indeed, in such an ecosystem, it may be possible for ISPs to “cross-over” with other business models and begin to provide portal and content value in addition to simple internet access. Therefore, such an ecosystem based on an extended business-model space may allow the evolution of more sophisticated models.

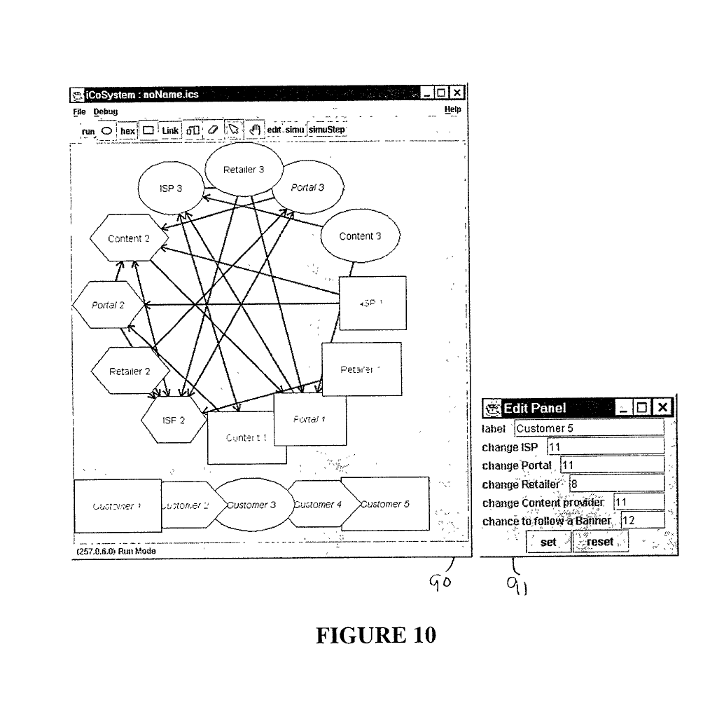

FIG. 10 illustrates exemplary screen displays from a simulation system for such an extended ecosystem. Window 90 illustrates a simple example of such an extended ecosystem with three ISPs—ISP1, IPS2, and ISP3—three portals—portal1, portal2, and portal3—three content providers—content1, content2, and content3—and also three retailers—retailer1, retailer2, and retailer3. Arrows represent purchasing relationships (A->B means that A buys goods or services from B). Parameters for business methods include: selling price for product or service, and, for portals, a fixed rate plus a variable rate for selling ad banners that depends on how many end customers click through the banner. In addition there are five parameterized customers (or classes of customers). Window 91 illustrates entry of exemplary customer parameters, which may include a likelihood to choose a value depending on price, a propensity to change providers, and a probability to access an advertiser from a displayed advertisement.

### Details of ISP Ecosystem Implementation

Next, the actual implementation of an ISP example is described. This implementation described a basic ecosystem including only ISPs each having a single value proposition (VP), operational approach (OA), and revenue mechanism (RM).

In this example, each building block was defined by a single parameter, and the space of ISP business models was accordingly defined as an N-dimensional parameter space, where N is the number of parameters that were evolved. In order to simplify encoding, all building blocks were encoded in every ISP, with the absence of a building block in a given ISP being indicated by setting a presence parameter to be equal to 0. Briefly, the building blocks were defined as follows:

Value Proposition (VP): internet access service, with or without advertising, with a given quality of service, and with a particular price scheme;

Operational Approach (OA): level of service actually provided, and responsiveness to service complaints; and

Revenue Mechanism (RM): monthly and per minute fees, and advertising fees.

A genetic algorithm was used as the evolutionary method. In order that the genomes were of fixed length, upper and lower bounds on values of the parameter defining the building blocks were chosen as follows:

| | |
|---|---|
| Monthly Fee: | 0 . . . 50 |
| Minute Fee: | 0 . . . 0.01 |
| Responsiveness: | 0 . . . 0.5 |
| Advertising: | 0 or 1 |

These parameters reflected basic decisions that an ISP made in this example, and in each generation, an ISP had defined values for each of these parameters. Briefly, the monthly fee was the customer charge to sign up for service with the ISP. The minute fee was the customer charge for each minute of ISP connect time. Responsiveness was a threshold above which an ISP would respond to poor service complaints from customers. A lower value of responsiveness meant that the ISPs are more likely to buy more servers. As the servers (the number of which per 1000 customers reflected the quality of service) were expensive, the ISP needs to decide on a reasonable amount of customer responsiveness so that its model remained profitable. Finally, the advertising value was a boolean value, 0 or 1, which reflected the ISP's decision to advertise (or not). On the one hand, the advertising was a valuable revenue stream, but on the other, the customers associated a decreased value with advertising which affected their decision in choosing the ISP in the first place, and thus possibly affected ISP market share. Initial business models were created by random choices of the building-block parameters.

Customers of the ecosystem were assigned a range of profiles intended to reflect different customer characteristics that might have actually existed. Importantly, this example represented that different packages of offerings from ISPs might have been attractive to different customers. Therefore, it was possible for an ISP in this example to succeed by serving only a limited population of customers by providing a focused value proposition (a “niche player”). For example, one customer population was “power users”, who needed many hours of access per day with better service and no advertising, and, perhaps, could have been serviced by ISPs offering a higher monthly (sign-up) fee while providing lower per minute fees, good service, and no advertising. Another use population was “household users”, who needed only minutes of access per day and would accept poorer service and advertisements for lower fees, and, perhaps, would have been serviced by ISPs offering lower prices but with fewer service guarantees and advertisements. These customer populations are exemplary, and this example could have been adapted to other customer populations.

Further, customers were not static and were assigned to particular ISPs. At each generation, each ISP received a new set of customers defined by profiles generated by the following function:

function [Users, ISP] = GenerateUsers (Users, ISP)
for i = 1:length(Users)
Users(i) .MinutesPerDay = ceil(rand*720);
Users(i) .CostOfAdvertising = ceil(rand*.1);
Users(i) .CostOfSpeed = ceil(rand* .1);
Users(i) .TooMany = ceil(length(Users)/10);
end

The new customers were offered the ISP service and responded to it according to their generated profile.

Briefly, each customer had a MinutesPerDay parameter, which defined the customer's minutes of access per day and was between 1 and 720. Next, each customer had a TooMany parameter, which defined the customer's tolerance for slower service and was between 1 and 10 percent. When TooMany customers (out of the total number of customers) were connected to the same ISP, the customers would be dissatisfied with the ISP's service and would complain. Related to slow-service tolerance was a cost of slow service. For each customer, the parameter CostOfSpeed represented a willingness to pay more fees for better service and had values between 0.0 and 0.1 which were comparable to the MinuteFee charged by the ISPs. Customers with higher CostOfSpeed parameters are more demanding. A CostOfAdvertising parameter with values between 0.0 and 0.1 represents the cost to a customer of having unsolicited advertising presented. Finally, a NoToSwitch parameter, which is defined elsewhere, represented the number of customer service complaints per day above which a customer decides to switch to another ISP.

The preferred random number generator used in this function had uniform distribution. Alternatively, in order to identify prototypical customer populations, such as the power customer or the household customer, the random number generator had a distribution formed by superposed gaussian curves, each gaussian defining values for prototypical customers and having a width reflecting the percentage of customers having that profile.

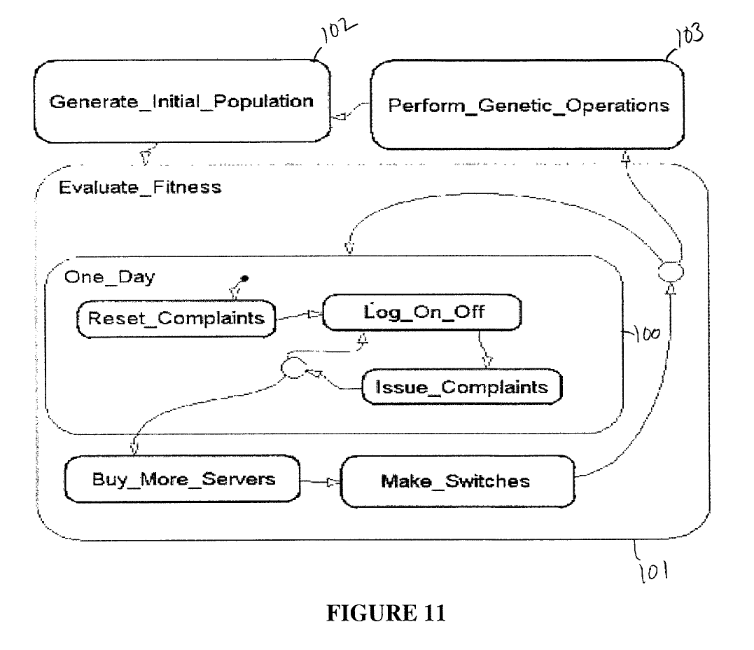

Next, the simulation/evolution program used in this example is described in terms of the ISP-business-model description and the profiled customers. FIG. 11 generally illustrates this simulation/evolution program. Processing 100 for one day of the simulation generally proceeded as follows. First, complaint counters were reset for the day, and the customers chose, or signed-up, with ISPs. Then, according to their profiles, customers logged on to their chosen ISPs, accessed their services, and logged off after their expected access time. During their access, customers might have issued complaints depending on the load on their ISPs and their tolerance of slow service. Next, during daily processing 101, ISPs, according to their business models, bought more servers in order to provide better service quality, and customers, according to their profiles, switched ISP if they were dissatisfied by the service from their previous ISP. Signing-up with ISPs, accessing ISP services, and advertising resulted in ISP revenue, while server purchases resulted in ISP costs. ISP market shares changed according the difference between the new customers who signed-up and the former customers who switched.

After a simulation for a determined number of days, fitness of the ISP business models was evaluated. In this example, fitness was chosen simply to be ISP profit, that is revenues minus costs. Fitness of each ISP was dependent on the other ISPs the particular simulation.

After fitness of all the individual ISP business models was evaluated, ISP models for the next round of simulation were determined. This involved generating or selecting an initial business model population 102 based upon application of genetic operators 103 to the fittest models from the prior round of simulation (“breeding” new models). The method used in this example to select the “fittest” business models from the prior round of simulation is known as tournament selection. First an individual model, I, was chosen randomly from the population. A second individual model, J, was also chosen, and then these two individuals entered into a “tournament”. A uniformly distributed random number was chosen between 0 and 1, and if its value was less than the value of the parameter “StrongSurvive”, then the individual model with the higher fitness (“stronger”) was selected for the next round. Otherwise, the individual model with the lower fitness (“weaker”) was selected. This process ensured that slightly more fit business models did not quickly dominate the population. The value of StrongSurvive used was 0.75, meaning that the individual with the higher fitness survived three times our of four. The selection procedure follows.

```
function newagent=DoTournamentSelection(agent, newagent,
StrongSurvive)
L = length(agent);
for k=1:length(agent)
i = ceil(rand*L);
j = ceil(rand*L);
if agent(i) .Fitness > agent(j) .Fitness
    if rand < StrongSurvive
      newagent(k) = agent(i);
    else
      newagent(k) = agent(j);
    end
else
    if rand < StrongSurvive
      newagent(k) = agent(j);
    else
      newagent(k) = agent(i);
    end
end
end
```

Next, genetic operators were applied to all the individual models that were selected according to this tournament selection. This model used the two preferable genetic operations, cross-over and mutation. In our example, each individual is sequentially considered first for crossover, and then for mutation. For each business model, the crossover probability was selected to be 0.75. If a model was selected for a cross-over, a second model was randomly chosen from the population of models, and a uniformly distributed random number was chosen between 1 and the length of the ISP “chromosome”. A “chromosome” in a genetic algorithm is a bit string representation of the parameters defining each member of the evolving population. Here, the ISP chromosomes were 47 bits long. At this cross-over point, bit string parameter representations of the two models were exchanged. Only the combination of the first individuals initial chromosome string with the second individuals tail chromosome string was placed into the next generation. The other offspring of the cross-over (first's tail with second's initial string) was not considered. (In other genetic algorithms, the second individual is also inserted into the population.)

Next, each individual ISP model was considered for a mutation event. A uniformly distributed random number was chosen between 0 and 1, and if it was is less that the value of the MutationRate parameter then a mutation event was performed. The MutationRate parameter was chosen to be 0.03. If a mutation was performed, then another uniformly distributed random number between 1 and the length of the ISP chromosome was chosen to determine the site of the mutation. At the determined site, if there was initially a 0 bit, it was changed to a 1 bit, and vice versa.

The genetic operation procedure follows.

```
function newagent = Modifypopulation(newagent, crossover, mutate)
L = length(newagent);
G = length (newagent (1) Genome);
for k = l:length(newagent)
i = ceil(rand*L);
j = ceil(rand*L);
L = length(newagent);
Temp = zeros(G,1);
point = ceil(rand * G);
if rand < crossover
    Temp(1:point) = newagent(i) .Genome(1:point);
    newagent (i) .Genome(1:point) = newagent(j) .Genome(1:point);
    newagent(j) .Genome(1:point) = Temp(1:point);
end
if rand < mutate
    if newagent(j) .Genome(point) == ‘1’
      newagent(j) .Genome(point) = ‘0’ ;
    else
      newagent(j) .Genome(point) = ‘1’ ;
    end
end
end
```

In more detail, the principal parameters of the simulation/evolution program were as follows.

Environment Profile:

| | |
|---|---|
| Number of ISPs: | 15 |
| Number of Customers: | 1000 |
| Cost of a new server: | 10000 |
| Price of Advertising Space: | 0.01 |

Genetic algorithm parameters:

| | |
|---|---|
| Number of Generations: | 50 |
| Number of days per generation: | 30 |
| Crossover rate: | 0.75 |
| Mutation rate: | 0.03 |
| Probability that ISP with the higher fitness survives: | 0.75 |
| Number of Minutes in each day: | 720 (12 hours) |

Performance model: Fitness is calculated as the profitability of the ISP,

where profitability equaled revenue (monthly fees, minute fees, and

advertising revenue) minus expenses (purchase of new servers).

The model was coded for the MATLAB package (The Mathworks, Inc., Natick, Mass., www.mathworks.com). MATLAB is a well known program package for technical computing and modeling.

### Results of ISP Ecosystem

Here, results of the example ISP ecosystem, and of a similar ecosystem, are described. These results demonstrate the usefulness and success of the present invention.

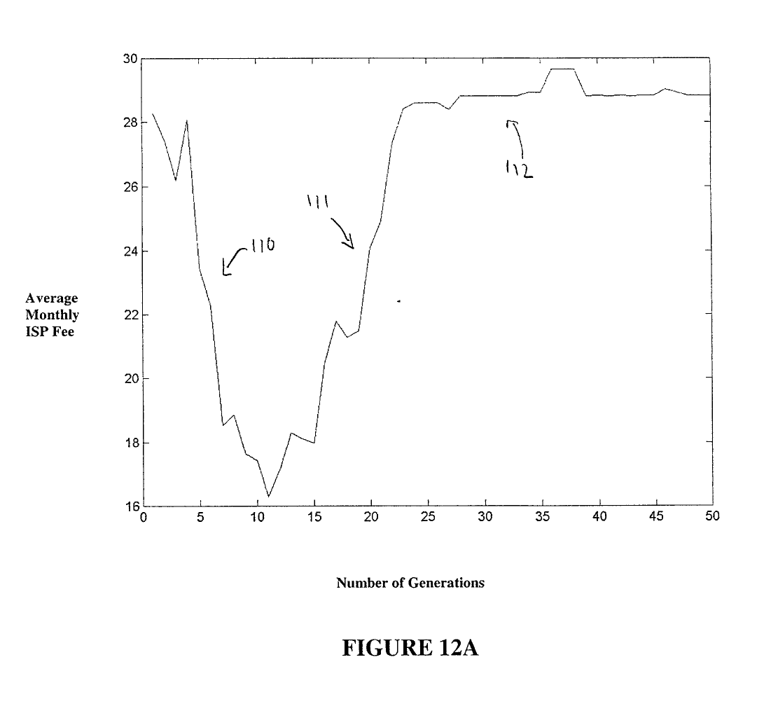

First, simulation of the example described above predicted the emergence and disappearance of ISPs charging few or no fees. This prediction is illustrated with respect to FIG. 12A, which plots, for an instance of ecosystem simulation, the average monthly ISP fee versus the number of generations of the evolution program. Initially, ISP business models competed for customers and profits by lowering their monthly fees while deriving an increasing share of income from advertising revenues. Some ISP models indeed even eliminated their monthly few altogether. Thus in period 110, average monthly ISP fees steeply declines.

However, as more ISPs rely increasingly on advertising revenue to compensate for lower customer fees, the available advertising revenue became spread across too many ISPs, and such ISP models became unprofitable. These unprofitable ISP models gradually disappeared from the ecosystem in succeeding generations in favor of fee-based ISP business models. Thus in period 111, average monthly ISP fees rose. Finally, in this simulation at least for generations in the period 112, ISP fees stabilized at approximately their initial levels.

This prediction, illustrated in FIG. 12A, reflects a well-known evolution that has occurred and is still occurring in actual real-world ISPs. Therefore, even a relatively simple application of the present invention has been demonstrated to produce reasonable and useful predications.

Next, FIG. 12B schematically illustrates an instance of a simulation of a more extended ecosystem than the example just described. This extended ecosystem, having the structure previously illustrated in FIG. 10, includes three business models of retailers, three business models of content providers, and three business models of portals, as well as three business models of ISPs. Here profits, revenue, and market share for all the models in the ecosystem are presented: window 113 presents performance of the three portals; window 114 presents performance of the three content providers; window 115 presents performance of the three ISPs; and window 116 presents performance of the three ISPs.

Each of the individual business models of each type demonstrated reasonable relative performance. For example, content provider 3 is losing in the competition with the other two content providers, while each of the ISPs, portals, and retailers are at worst economically steady. Also, the retailers, although gaining steadily in revenue, are having difficulty maintaining profitability. This is another known effect of actual internet retailers.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

A number of references are cited herein, the entire disclosures of which are incorporated herein, in their entirety, by reference for all purposes. Additionally, U.S. Provisional Patent Application serial No. 60/187,889, filed Mar. 8, 2000, to which this application claims priority, is also incorporated herein, in its entirety, by reference for all purposes. Further, none of these references, regardless of how characterized above, is admitted as prior to the invention of the subject matter claimed herein.

### Appendix

The following is a MATLAB program file for the ISP example. This program file is © 2000 Icosystem, Inc.

function ISPrun
d = date;
str = [‘ISP’ d]
save DATAE.mat d
%eval([‘save str ’ ])
NAXI = {};
AVGI = {};
NAXU = {};
AVGU = {};
ISPs = {};
USplits = {};
MSplits = {};
LENGTH = 1+16+16+16; %Advertising, NonthlyFee, MinuteFeePop-
Size = 10;

| | |
|---|---|
| LENGTHu = 16+16+16; | %NoToSwitch, |

UserSize = 100;
PopSize = 10;
generations = 100;
crossover = .75;
mutate = .03;
StrongSurvive = .75;
NDays = 30;
MaxNoToSwitch .5;
MaxSF1 = 2000;
MaxSF2 = 10;
MaxNonthlyFee = 50;
MaxMinuteFee .01;
MaxResponsiveness = .5;

| | |
|---|---|
| costof = 10000; | % Cost of a new Server |
| priceof = .01; | % Price of Advertising Space |

```
rand( ‘state’,sum(100*clock));
ISPTYPE = struct(‘Advertising’, 0, ‘MonthlyFee’, 0, ‘MinuteFee’, ...
0, ‘Responsiveness’, 0, ‘Complaints’, 0, ‘NoServers’, 1, ‘NewServers’,
0, ...
‘NoSubscribers’, 0, ‘NoRightNow’, 0, ‘NoSubscriberMins’, 0, ...
‘Revenue’, 0, ‘Expenses’, 0, ‘Genome’, num2str(zeros(LENGTH,1)),
‘Fitness’, 0);
ISP(1:PopSize) = ISPTYPE;
newISP(1:PopSize) = ISPTYPE;
USERTYPE = struct (‘MinutesPerDay’, 0, ‘CostOfAdvertising’, 0,
‘CostOfSpeed’, 0,...
‘TooMany’, 0, ‘NoToSwitch’, 0, ‘CurrentProvider’, 0, ‘PaidFor’,
zeros(PopSize,1), ‘Complaints’, 0, ...
‘PayOut’, 0, ‘SpeedFactor1’, 0, ‘SpeedFactor2’, 0, ‘Genome‘,
num2str(zeros(LENGTHu,1)), ‘Fitness’, 0);
Users(1:UserSize) = USERTYPE;
newUsers(1:UserSize) = USERTYPE;
for i=1:generations
if i == 1
    ISP = GenerateRandomPopulation(ISP);
    [Users ISP] = GenerateUsers(Users,ISP);
    else
    newISP = DoTournamentSelection(ISP,newISP, StrongSurvive);
    %newUsers = DoTournamentSelection(Users, newUsers,
StrongSurvive);
    ISP = ModifyPopulation(newISP, crossover,mutate);
%Users = ModifyPopulation(newUsers, crossover,mutate);
end
ISP = MapToValues (ISP,MaxMonthlyFee, MaxMinuteFee,Max-
Responsiveness);
Users = MapToValuesU(Users,MaxNoToSwitch,MaxSF1,MaxSF2);
[ISP Users] = ResetOtherThings(ISP,Users);
[ISP Users] = PickIsp(ISP,Users,NDays);
tic
[ISP Users USplit MSplit] = RunNDays(ISP, Users,NDays,costof,
priceof);
toc
[MAX AVG ISP] = EvaluatePop(ISP);
[MAXu AVGu Users] = EvaluatePopU(Users);
str1 = [‘ISP’ num2str(i)];
str2 = [‘Users’ num2str(i)];
str3 = [‘USplit’ num2str(i)];
str4 = [‘MSplit’ num2str(i)];
%eval([‘load’ str])
MAXI{i} = MAX;
AVGI{i}= AVGI;
MAXU{i} = MAXu;
AVGU{i} = AVGU;
ISPs{i} = ISP;
USplits{i} = USplit;
MSplits{i} = MSplit;
save DATAE.mat MAXI AVGI MAXU AVGU TSPs USplits
MSplits d i
%eval([str1 ‘ = ISP;’]);
%eval([str2 ‘ = Users;’]);
%eval([str3 ‘ = USplit;’]);
%eval([str4 ‘ = MSplit;’]);
%eval([‘save str ’ ‘ str1 ’ ‘ str2 ’ ‘ str3 ’ ‘ str4 ’ MAXI AVGI
MAXU AVGU -append’]);
%eval([‘save ’ str ‘ ’ str1 ’ ‘ str3 ’ ‘ str4 ’ MAXI AVGI MAXU
AVGU -
append’]);
disp(i)
disp([‘Average Fitness of Users: ‘ num2str(AVGu) ’ Max Fitness of
ISPs: ‘ num2str(MAX)])
end
PrintPopulation (ISP)
function [Users, ISP] = GenerateUsers(Users,ISP)
for i = 1:length(Users)
Users(i).MinutesPerDay = ceil(rand*720);
Users(i).CostOfAdvertising = ceil(rand*.1);
Users(i).CostOfSpeed = ceil(rand*.1);
Users(i).TooMany = ceil(length(Users)/10);
end
function [ISP, Users] = ResetOtherThings(ISP,Users)
for i = 1:length(ISP)
    ISP(i).NoSubscribers = 0;
ISP(i).NoServers = 1;
ISP(i).Revenue = 0;
ISP(i).Expenses = 0;
end
for j = 1:length(Users)
Users(j).PaidFor = zeros(length(ISP),1);
Users(j).PayOut = 0;
end
function agent = GenerateRandomPopulation(agent)
for i = 1:length(agent)
for j = 1:length(agent(i).Genome)
    if rand > .5
      agent(i).Genome(j) = ‘1’;
    end
end
end
function [ISP, Users, USplit,MSplit] = RunNDays(ISP, Users,
NDays,costof,priceof)
USplit = zeros(length(ISP),NDays);
MSplit = zeros(length(ISP),NDays);
Service = zeros(length(ISP),NDays);
Ad = zeros(length(ISP),1);
Mon = zeros(length(ISP),1);
Min = zeros(length(ISP),1);
Res = zeros(length(ISP),1);
for j = 1:NDayS
[ISP, Users] = ResetComplaints(ISP,Users);
Disconnect = zeros(length(Users),1);
uW = (1:length(Users));
uC = [];
for minute = 1:720
    [ISP Users uW uC Disconnect] = ConnectNew(ISP, Users,
minute, uW,
uC,Disconnect);
    X = find(Disconnect == minute);
        if ˜isempty(X)
      [Users ISP uC] = DisconnectOld(ISP, Users, minute, uC,
Disconnect,X);
    end
    for ii = 1:length(ISP)
      ISP(ii).NoSubscriberMins = ISP(ii).NoSubscriberMins +
ISP(ii).NoRightNow;
    end
      [ISP Users] = IssueComplaints(ISP, Users, uC);
end
[ISP Users] = CalcPayout(ISP,Users,priceof);
S = zeros(length(ISP),1);
for n = 1:length(ISP)
    USplit(n,j) = ISP(n).NoSubscribers;
    MSplit(n,j) = floor((ISP(n).Revenue-ISP(n).Expenses));
    Ad(n,1) = ISP(n).Advertising;
    Mon(n,1) = floor(ISP(n).MonthlyFee);
    Min(n,1) = floor(ISP(n).MinuteFee);
        Res(n,1) = floor(ISP(n).Responsiveness*100);
    %Service(n,j) = (ISP(n).Complaints / ISP(n).NoSubscriberMins+1);
    %disp([‘Day ’ num2str(j) ‘, ISP(’ num2str(n) ‘) has ’
num2str(ISP(n).NoSubscribers)
    % ‘ subscribers, and $’ num2str(floor((ISP(n).Revenue-
ISP(n).Expenses)))]) %,...
    %‘ Ad, ’ num2str(ISP(n).NoRightNow), ‘ ’, ...
    %num2str(ISP(n).NoSubscriberMins), ‘ ’,
num2str(ISP(n).Complaints)]);
end
subplot (2,1,1)
plot (USplit (:,1:j)’)
subplot (2,1,2)
plot (MSplit (:,1:1)’)
drawnow
disp([‘Day: ’ num2str(j)]);
Z = []
Z= [USplit(:,j) MSplit(:,j) Ad(:,1) Mon(:,1) Min(:,1) Res(:,1)];
%disp(Z);
%disp (USplit (:,j)
%disp (MSplit (:,j))
ISP = BuyMoreServers(ISP, costof);
[ISP, Users] = MakeSwitches(ISP,Users,NDays);
% drawnow
end
function [ISP, Users, uWStill, uC, Disconnect] =
ConnectNew(ISP,Users,minute,uW,uC,Disconnect)
uWStill = [];
for user = 1:length(uW)
cur = uW(user);
P = 1 - ((720 - minute - Users(cur).MinutesPerDay) / 720);
if rand < P
    uC = [uC cur];
    Disconnect(cur) = minute +Users(cur).MinutesPerDay;
    isp = Users(cur).CurrentProvider;
        ISP(isp).NoRightNow = ISP(isp).NoRightNow +1;
else
    uWStill = [uWStill cur];
end
end
function [Users, ISP, uC] =
DisconnectOld(ISP,Users,minute,uC,Diconnect,X)
for i= 1:length(X)
    cur
    te find(uC == cur);
    uC(te) = [];
    isp = Users(cur).CurrentProvider;
    ISP(isp).NoRightNow = ISP(isp).NoRightNow - 1;
end
function [ISP, Users] = IssueComplaints(ISP, Users, uC)
for i=1:length(uC)
cur = uC(i);
isp = Users(cur).CurrentProvider;
% If its too slow issue a complaint
  %disp(ISP(isp).NoRightNow / ISP(isp).NoServers)
  %disp(Users(cur).TooMany)
if (ISP(isp).NoRightNow / ISP(isp).NoServers) > Users(cur).TooMany
    Users(cur).Complaints = Users(cur).Complaints +1;
    %disp(ISP(isp).Complaints)
    ISP(isp).Complaints = ISP(isp).Complaints + 1;
end
end
function ISP = BuyMoreServers(ISP, costof)
for i=1:length(ISP)
%if (ISP(i).Revenue - ISP(i).Expenses) > -100000
    if ISP(i).Complaints / (ISP(i).NoSubscriberMins+1) >=
ISP(i).Responsiveness
      %B = ceil((ISP(i).Responsiveness * ISP(i).NoServers)/...
      % (ISP(i).Complaints / ISP(i).NoSubscriberMins)) -
ISP(i).NoServers;
      B=
ceil ((ISP(i).Complaints*ISP(i).NoServers/ISP(i).NoSubscriberMins)/...
        (ISP(i).Responsiveness)) - ISP(i).NoServers;
      %mB = (100000 + ISP(i).Revenue - ISP(i).Expenses) / costof;
      %if mB <= 0
      % mB = 0;
      %end
      %if B > mB
      % B = floor(mB);
      %end
      ISP(i).NoServers = ISP(i).NoServers + B;
      disp([num2str(i) ‘ now has ’ num2str(ISP(i).NoServers) ‘
servers ’]);
      ISP(i).Expenses = ISP(i).Expenses * B + costof;
      ISP(i).NewServers = B;
      else
      ISP(i).NewServers = 0;
    end
%else
% ISP(i).NewServers = 0;
% end
end
% Just log the complaints, then at the end of the day, consider switching
% Allow ISP's to upgrade their service first, then let the users switch.
function [ISP, Users] = MakeSwitches(ISP, Users,NDays)
for i=1:length(Users)
isp = Users(i).CurrentProvider;
% If its too slow issue a complaint
if (Users (i).Complaints / Users (i).MinutesPerDay)
        * ((ISP(isp).NoServers -
ISP(isp).NewServers)/ISP(isp).NoServers)...
        > Users(i).NoToSwitch
        [ISP Users(i)] = PickIsp1(ISP,Users(i),NDays);
end
end
function [ISP, Users] = ResetComplaints(ISP, Users)
for i=1:length(Users)
Users(i).Complaints = 0;
%Users(i).PayOut = 0;
end
for i=1:length(ISP)
ISP(i).NoRightNow = 0;
ISP(i).Complaints = 0;
ISP(i).NoSubscriberMins = 0;
end
function [ISP, Users] = CalcPayout(ISP,Users,priceof)
for i=1:length(Users)
isp = Users(i).CurrentProvider;
M = Users(i).MinutesPerDay;
Users(i).PayOut = Users(i).PayOut + TSP(isp).MinuteFee * M;
%if ISP(isp).Advertising == 1;
% Users(i).PayOut = Users(i).PayOut +
Users(i).CostOfAdvertising *
M;
%end
ISP(isp).Revenue = ISP(isp).Revenue + ISP(isp).MinuteFee * M + ...
    ISP(isp).Advertising * M * priceof * M / ((Users(i).Cornplaints+1));
%establishes relationship
```

% between QoS and value of Advertising

```
Users(i).PayOut Users(i).PayOut + Users(i).Complaints *
Users(i).CostOfSpeed;
end
function [MAX, AVG, ISP]= EvaluatePop(ISP)
for i = 1:length(ISP)
ISP(i).Fitness = (ISP(i).Revenue - ISP(i).Expenses);
if ISP(i).MoSubscribers < 2
    ISP(i).Fitness ==−10\hat{ }5;
end
F(i,1) = -ISP(i).Fitness;
end
[A, B] = sort(F);
ISP = TSP(B);
MAX = max(-F);
AVG = mean(-F);
function [MAX, AVG. Users] = EvaluatePopU(Users)
F = zeros(length(Users),1);
for i = 1:length(Users)
Users(i).Fitness = - Users(i).PayOut;
F(i,1) = Users(i).Fitness;
end
[A, B] = sort(F);
Users = Users(B);
MAX = max(F);
AVG = mean(F);
function ISP = MapToValues(ISP, MaxMonthlyFee,
MaxMinuteFee, MaxResponsiveness)
for i=1:length(ISP)
Mo = ISP(i).Genome(2:17);
Mi = ISP(i).Genome(17+1:L7+16);
RC = ISP(i).Genoxne(33:32+16);
ISP(i).Advertising = str2num(ISP(i).Genome(1));
ISP(i).MonthlyFee = BitToArabic(Mo) * MaxMonthlyFee / 2\hat{ }16;
ISP(i).MinuteFee = BitToArabic(Mi) * MaxMinuteFee / 2\hat{ }16;
ISP(i).Responsiveness BitToArabic(RC) * MaxResponsiveness / 2\hat{ }16;
end
function Users = MapToValuesU(Users,MaxNoToSwitch,
MaxSF1,MaxSF2)
for i=1:length(Users)
No = Users(i).Genome(1:16);
S1 = Users(i).Genome(16+1:16+16)
S2 = Users(i).Genome(32:31+16);
Users(i).NoToSwitch = BitToArabic(No) * MaxNoToSwitch / 2\hat{ }16;
Users(i).SpeedFactor1 = BitToArabic(S1) * MaxSF1 / 2\hat{ }16;
Users(i).SpeedFactor2 = BitToArabic(S2) * MaxSF2 / 2\hat{ }16;
end
function [ISP, Users] = Picklspl(ISP,Users,NDays)
minCost = 10\hat{ }10;
pick = 1;
SKIP = = Users.Currentprovider;
for j = 1:length(ISP)
if j ˜= SKIP
    %cost =
ISP(j).Advertising*Users.CostOfAdvertising*Users.MinutesPerDay*
NDays +
...
    % Users.CostOfSpeed*((ISP(j).NoSubscribers / ISP
(j).NoServers) *
...
    % (Users.SpeedFactor1/Users.TooMany)\hat{ }Users.
SpeedFactor2) + ...
    % + ISP(j).MonthlyFee +
ISP(j).MinuteFee*Users.MinutesPerDay*NDays;
    cost = ISP(j).MonthlyFee + (ISP(j).MinuteFee +
ISP(j).Advertising*Users.CostOfAdVertising + ...
      (ISP(j).NoSubscribers / ISP(j).NoServers) *
ISP(j).Responsiveness*Users.CostOfSpeed) ...
      * Users.MinutesPerDay*NDays;
    if Users.PaidFor(j) == 1
      cost = cost - ISP(j).MonthlyFee;
    end
    if cost < minCost
      minCost = cost;
      pick = j;
    elseif cost == minCost;
      pick = [pick i];
    end
end
end
if length(pick) > 1
P = ceil(rand*length(pick));
pick = pick(P);
end
ISP(pick).NoSubscribers = ISP(pick).NoSubscribers + 1;
ISP(SKIP).NoSubscribers = ISP(SKIP).NoSubscribers − 1;
Users.CurrentProvider = pick;
if Users.PaidFor(pick) ˜= 1
ISP(pick).Revenue = ISP(pick).Revenue + ISP(pick).MonthlyFee;
Users.PayOut = Users.PayOut + ISP(pick).MonthlyFee;
Users.PaidFor(pick) = 1;
end
function [ISP, Users] = Picklsp(ISP,Users,NDays)
minCost = 10\hat{ }10;
pick = 1;
for i=1:length(Users)
SKIP = Users(i).CurrentProvider;
for j = 1:length(ISP)
if j ˜= SKIP
    %cost =
ISP(j).Advertising*Users(i).CostOfAdvertising*Users(i).MinutesPerDay +
...
    % Users(i).CostOfSpeed*((ISP(j).NoSubscribers /
ISP(j).NoServers)
* ...
    % (Users(i).SpeedFactor1/Users(i).TooMany)\hat{ }Users(i).
SpeedFactor2)
+ ...
    cost = ISP(j).NonthlyFee +(ISP(j).MinuteFee...
      +TSP(j).Advertising*Users(i).CostofAdvertising + ...
      ISP(j).Responsiveness * Users(i).CostOfSpeed) ...
      * Users(i).MinutesperDay*NDays;
    if cost < minCost
      minCost = cost;
      pick = j;
    elseif cost == minCost;
      pick = [pick j];
    end
end
end
if length(pick) > 1
P = ceil(rand*length(pick));
pick = pick(P);
end
ISP(pick).NoSubscribers = ISP(pick).NoSubscribers + 1;
ISP(pick).Revenue = ISP(pick).Revenue + ISP(pick).MonthlyFee;
Users (i).PayOut = Users(i).PayOut + ISP(pick).MonthlyFee;
Users(i).CurrentProvider = pick;
end
function newagent = ModifyPopulation(newagent, crossover, mutate)
L = length(newagent);
C = length(newagent(1).Genome);
for k = 1:length(newagent)
i = ceil(rand*L);
j = ceil(rand*L);
L = length(newagent);
Temp = zeros(G,1);
= point ceil(rand *
if rand < crossover
    Temp(1:point) = newagent(i).Genome(1:point);
    newagent(i).Genome(1:point) = newagent(j).Genome(1:point);
    newagent(j).Genome(1:point) = Temp(1:point);
end
if rand < mutate
    if newagent(j).Genome(point) == ‘1’
    newagent(j).Genome(point) = ‘0’;
    else
      newagent(j).Genome(point) = ‘1’;
    end
end
end
function PrintPopulation(agent)
for i=1:length(agent)
%disp([agent(i).Genome‘ ’ ’ num2str(agent(i).Fitness)]);
```

| | |
|---|---|
| disp([‘Advertising: | ’, num2str(agent(i).Advertising)]) |
| disp([‘MonthlyFee: | ’, num2str(agent(i).MonthlyFee)]) |
| disp([‘MinuteFee: | ’, num2str(agent(i).MinuteFee)]) |
| disp([‘NoServers: | ’, num2str(agent(i).NoServers)]) |
| disp([‘NoSubscribers: | ’, num2str(agent(i).NoSubscribers)]) |
| disp([‘Responsiveness: | ’, num2str(agent(i).Responsiveness)]) |
| disp([‘Fitness: | ’, num2str(agent(i).Fitness)]) |

```
disp([‘ ’])
end
function r = BitToArabic(str)
L = length(str);
r=0;
for i = 1:L
if str(i) == ‘1’
    r = r + 2\hat{ }(L-i);
end
end
function newagent = DoTournamentSelection(agent, newagent,
StrongSurvive)
L = length(agent);
for k=1:length(agent)
i = ceil(rand*L);
j = ceil(rand*L);
if agent(i).Fitness > agent(j).Fitness
    if rand < StrongSurvive
      newagent(k) = agent(i);
    else
      newagent(k) = agent(j);
    end
else
    if rand < StrongSurvive
      newagent(k) = agent(j);
    else
      newagent(k) = agent(i);
    end
end
end
```

What is claimed is:

1. A method for generating business models for solving a selected business problem comprising:
describing a plurality of computer-simulateable business models, wherein a business model describes operations of businesses for solving the business problem, and wherein a business model has an associated operational performance model,
describing a business-model environment, wherein the business-model environment comprises a plurality of computer-simulateable customer models, wherein the customer models patronize the business models to receive values from the business models
determining the operational performances of the businesses described by the plurality of business models (i) by simulating the plurality of business models, and (ii) by simulating the environment, including simulating the customer models receiving values from the business models, and
generating a next plurality of business models from the simulated plurality of business models by performing an evolutionary method including
(i) determining business-model fitness in dependence on the operational business-model performances,
(ii) selecting one or more business models in dependence on their fitness, and
(iii) transforming the selected business models into new business models by applying one or more genetic operators, wherein the new business models incorporate elements of the selected business models.

2. The method of claim 1 further comprising a step of repeating one or more times the steps of determining and generating, wherein each step of determining simulates the plurality of business models resulting from the previous step of generating.

3. The method of claim 1 wherein the business models are elements in a space of business models for solving the business problem.

4. The method of claim 1 wherein at least two business models interact, and wherein the step of determining further comprises simulating interactions between business models.

5. The method of claim 1 wherein the genetic operators comprise a cross-over operator which transforms at least two parent business models into at least one new business model by combining characteristics of both parent business models into the characteristics of the at least one new business model.

6. The method of claim 1 wherein the genetic operators comprise a mutation operator which transforms a parent business model into a new business model by modifying a characteristic of the parent business model.

7. The method of claim 1 wherein the business models comprise parameter data specifying characteristics of the business operations described by the business models.

8. The method of claim 1 wherein business model descriptions comprises one or more computer-simulateable value propositions (VP) which describe output values provided by businesses.

9. The method of claim 8 wherein VPs comprise descriptions of the natures of one or more goods or services provided, or qualities of the goods or services, or customers for goods and services, or relations with other business models, or marketing to customers or business models.

10. The method of claim 1 wherein business model descriptions comprises one or more computer-simulateable operational approaches (OA) which describe inputs to businesses and transformations of inputs to output values by businesses.

11. The method of claim 10 wherein the OAs comprise descriptions of inputs needed for the goods or services provided, or technology employed to produce the goods or services, or capital and labor needed for production.

12. The method of claim 1 wherein business model descriptions comprises one or more computer-simulateable revenue mechanisms (RM) which describe pricing and cost models by which businesses acquire revenues.

13. The method of claim 12 wherein the RMs comprise descriptions of a margin or an amount per transaction, or per unit time, or per unit volume, or transaction pricing mechanism, or a subscription pricing mechanism, or a flat rate pricing mechanism, or a membership fee pricing mechanism.

14. The method of claim 1 wherein business models comprise descriptions of one or more inputs to a business, one of more values output from a business, one or more transformations of inputs into output values by a business, labor and capital required for a business, and one or more pricing models for a business.

15. A method for generating business models for solving a selected business problem comprising:
describing a plurality of computer-simulateable building blocks, wherein the building blocks comprise one or more business elements of the business problem, and wherein the building blocks further comprise (i) one or more computer-simulateable value proposition (VP) building blocks which describe output values provided by businesses, (ii) one or more computer-simulateable operational approach (OA) building blocks which describe inputs to businesses and transformations of inputs to output values by businesses, and (iii) one or more computer-simulateable revenue mechanism (RM) building blocks which describe pricing and cost models by which businesses acquire revenues,
generating an initial plurality of business models, wherein a business model describes operations of businesses for solving the business problem, and wherein a business model comprises a plurality of building blocks and an associated operational performance model,
determining the operational performances of the businesses described by the plurality of business models by simulating the plurality of business models, and
generating a next plurality of business models from the simulated plurality of business models by performing an evolutionary method, wherein the evolutionary method uses a fitness dependent on the operational business-model performances and applies genetic operators to the building-blocks of business models, and
repeating one or more times the steps of determining the operational performance and generating a next plurality of business models, wherein each step of determining simulates that plurality of business models resulting from the previous step of generating.

16. The method of claim 15 wherein the business models constructed from the building blocks forms a space of business models for solving the business problem.

17. The method of claim 15 wherein each business element comprises a description of only an input to a business, or only a value output from a business, or a transformation employed by a business, or only a consideration received by a business for an output value.

18. The method of claim 15 further comprising describing a business-model environment, wherein the business-model environment comprises a plurality of computer-simulateable customer models, wherein the customer models patronize the business models to receive values from the business models, and wherein the step of determining operational performances further comprises simulating the environment, including simulating the customer models receiving values from the business models.

19. The method of claim 18 wherein the customer models descriptions of customer behaviors, wherein the behaviors comprise patronizing a business model.

20. The method of claim 19 wherein the customer models descriptions of customer behaviors, wherein the behaviors further comprise choosing a business model to patronize and being idle.

21. The method of claim 15 wherein the evolutionary method comprises:
determining business-model fitness in dependence on the operational business-model model performances,
selecting one or more business models in dependence on their fitness, and
transforming the selected business models into new business models by applying one or more genetic operators, wherein the new business models incorporate elements of the selected business models.

22. The method of claim 21 wherein the genetic operators comprise a cross-over operator which transforms at least two parent business models into at least one new business model by selecting building blocks from both parent business models to be the building blocks of the at least one new business model.

23. The method of claim 21 wherein the genetic operators comprise a mutation operator which transforms a parent business model into a new business model by modifying a characteristic of a building block of the parent business model.

24. The method of claim 15 wherein each building block describes only one or more inputs to a business, or only one of more values output from a business, or only one or more transformations of inputs into output values by a business, or only one or more pricing models for a business, or only one or more performances of a business.

25. The method of claim 15 wherein VP building blocks comprise business elements describing the natures of one or more goods or services provided, or qualities of the goods or services, or customers for goods and services, or relations with other business models, or marketing to customers or business models.

26. The method of claim 15 wherein the OA building blocks comprise business elements describing inputs needed for goods or services provided, or technology employed to produce the goods or services, or capital and labor needed for production.

27. The method of claim 15 wherein the RM building blocks comprise business elements describing a margin or an amount per transaction, or per unit time, or per unit volume, or transaction pricing mechanism, or a subscription pricing mechanism, or a flat rate pricing mechanism, or a membership fee pricing mechanism.

28. A method for generating business models for solving a selected business problem the method comprising:
describing a plurality of computer-simulateable building blocks, wherein the building blocks comprise descriptions of one or more business elements of the business problem, and wherein business elements comprises descriptions of an input to a business, or a value output from a business, or a transformation employed by a business, or a consideration received by a business for an output value,
describing one or more computer-simulateable customer models, wherein the customer models patronize the business model to receive values from the business model,
determining the operational performance of a business described by a business model, wherein a business model comprises a plurality of building blocks and an associated operational performance model that describe operation of a business for solving the business problem, and wherein operational performance is determined (i) by simulating the business model, and (ii) by simulating the one or more customer models receiving values from the business model, and
generating a final business model of improved performance by performing an optimization method, wherein the optimization method (i) uses a fitness dependent on the operational business-model performances, and (ii) substitutes or alters one or more building blocks of the business model.

29. The method of claim 28 further comprising a step of repeating one or more times the steps of determining and generating, wherein each step of determining simulates that business model resulting from the previous step of generating.

30. The method of claim 28 wherein the optimization method comprises local search heuristics, or simulated annealing, or reinforcement learning, or adaptive computation and machine learning, or an evolutionary optimization method.

31. The method of claim 28 wherein the building blocks comprise one or more computer-simulateable value proposition (VP) building blocks which describe output values provided by businesses.

32. The method of claim 28 wherein the building blocks comprise one or more computer-simulateable operational approach (OA) building blocks which describe inputs to businesses and transformations of inputs to output values by businesses.

33. The method of claim 28 wherein the building blocks comprise one or more computer-simulateable revenue mechanism (RM) building blocks which describe pricing and cost models by which businesses acquire revenues.

34. A method for generating business models for solving a selected business problem comprising:
describing a plurality of computer-simulateable building blocks, wherein the building blocks include one or more business elements of the business problem and further comprise
(i) one or more computer-simulateable value proposition (VP) building blocks which describe output values provided by businesses by comprising information describing the natures of one or more goods or services provided, or qualities of the goods or services, or customers for goods and services, or relations with other business models, or marketing to customers or business models,
(ii) one or more computer-simulateable operational approach (OA) building blocks which describe inputs to businesses and transformations of inputs to output values by businesses by comprising information describing inputs needed for goods or services provided, or technology employed to produce the goods or services, or capital and labor needed for production, and
(iii) one or more computer-simulateable revenue mechanism (RM) building blocks which describe pricing and cost models by which businesses acquire revenues by comprising information describing a margin or an amount per transaction, or per unit time, or per unit volume, or transaction pricing mechanism, or a subscription pricing mechanism, or a flat rate pricing mechanism, or a membership fee pricing mechanism,
generating an initial plurality of business models, wherein a business model describes operations of businesses for solving the business problem, and wherein a business model comprises a plurality of building blocks and an associated operational performance model,
determining the operational performances of the businesses described by the plurality of business models by simulating the plurality of business models, and
generating a next plurality of business models from the simulated plurality of business models by performing an evolutionary method, wherein the evolutionary method uses a fitness dependent on the operational business-model performances and applies genetic operators to the building-blocks of business models, and
repeating one or more times the steps of determining the operational performance and generating a next plurality of business models, wherein each step of determining simulates that plurality of business models resulting from the previous step of generating.

35. A method for generating business models for solving a selected business problem comprising:
describing a plurality of computer-simulateable building blocks, wherein the building blocks include one or more business elements of the business problem and further comprise
(i) one or more computer-simulateable value proposition (VP) building blocks which describe output values provided by businesses by comprising information describing the natures of one or more goods or services provided, or qualities of the goods or services, or customers for goods and services, or relations with other business models, or marketing to customers or business models,
(ii) one or more computer-simulateable operational approach (OA) building blocks which describe inputs to businesses and transformations of inputs to output values by businesses by comprising information describing inputs needed for goods or services provided, or technology employed to produce the goods or services, or capital and labor needed for production, and
(iii) one or more computer-simulateable revenue mechanism (RM) building blocks which describe pricing and cost models by which businesses acquire revenues by comprising information describing a margin or an amount per transaction, or per unit time, or per unit volume, or transaction pricing mechanism, or a subscription pricing mechanism, or a flat rate pricing mechanism, or a membership fee pricing mechanism,
describing a business-model environment, wherein the business-model environment comprises a plurality of computer-simulateable customer models, wherein the customer models patronize the business models to receive values from the business models,
generating an initial plurality of business models, wherein a business model describes operations of businesses for solving the business problem, and wherein a business model comprises a plurality of building blocks and an associated operational performance model,
determining the operational performances of the businesses described by the plurality of business models by (i) simulating the plurality of business models and (ii) simulating the environment, including simulating the customer models receiving values from the business models, and
generating a next plurality of business models from the simulated plurality of business models by performing an evolutionary method, wherein the evolutionary method uses a fitness dependent on the operational business-model performances and applies genetic operators to the building-blocks of business models, and
repeating one or more times the steps of determining the operational performance and generating a next plurality of business models, wherein each step of determining simulates that plurality of business models resulting from the previous step of generating.

36. A method for generating business models for solving a selected business problem the method comprising:
describing a plurality of computer-simulateable building blocks, wherein the building blocks include one or more business elements of the business problem and further comprise
(i) one or more computer-simulateable value proposition (VP) building blocks which describe output values provided by businesses by comprising information describing the natures of one or more goods or services provided, or qualities of the goods or services, or customers for goods and services, or relations with other business models, or marketing to customers or business models,
(ii) one or more computer-simulateable operational approach (OA) building blocks which describe inputs to businesses and transformations of inputs to output values by businesses by comprising information describing inputs needed for goods or services provided, or technology employed to produce the goods or services, or capital and labor needed for production, and
(iii) one or more computer-simulateable revenue mechanism (RM) building blocks which describe pricing and cost models by which businesses acquire revenues by comprising information describing a margin or an amount per transaction, or per unit time, or per unit volume, or transaction pricing mechanism, or a subscription pricing mechanism, or a flat rate pricing mechanism, or a membership fee pricing mechanism,
describing a business-model environment, wherein the business-model environment comprises a plurality of computer-simulateable customer models, wherein the customer models patronize the business models to receive values from the business models,
determining the operational performance of a business described by a business model, wherein a business model comprises a plurality of building blocks and an associated operational performance model that describe operation of a business for solving the business problem, and wherein operational performance is determined (i) by simulating the business model, and (ii) by simulating the environment, including simulating the customer models receiving values from the business models, and
generating a final business model of improved performance by performing an optimization method, wherein the optimization method (i) uses a fitness dependent on the operational business-model performances, and (ii) substitutes or alters one or more building blocks of the business model.

37. The method of claim 36 wherein the optimization method comprises local search heuristics, or simulated annealing, or reinforcement learning, or adaptive computation and machine learning, or an evolutionary optimization method.

38. Computer executable software instructions stored on a computer readable medium, the software instructions for causing a computer to perform the method of claim 15.

39. Computer executable software instructions stored on a computer readable medium, the software instructions for causing a computer to perform the method of claim 35.

40. Computer executable software instructions stored on a computer readable medium, the software instructions for causing a computer to perform the method of claim 36.

41. A computer system for generating business models for solving a selected business problem comprising:
a processor, and
a memory accessible to the processor, wherein the memory is configured with software instructions and data for causing the processor to perform the method of claim 15.

42. A computer system for generating business models for solving a selected business problem comprising:
a processor, and
a memory accessible to the processor, wherein the memory is configured with software instructions and data for causing the processor to perform the method of claim 35.

43. A computer system for generating business models for solving a selected business problem comprising:
a processor, and
a memory accessible to the processor, wherein the memory is configured with software instructions and data for causing the processor to perform the method of claim 36.
